(19) United States
(12) Patent Application Publication
(10) Pub. No.: US 2026/0333325 A1
(43) Pub. Date: Oct. 22, 2026

(54) DYNAMIC RADIO BEARER CONFIGURATION

(71) Applicant: Lenovo (United States) Inc., Morrisville, NC (US)

(72) Inventors: Joachim Löhr, Wiesbaden (DE); Prateek Basu Mallick, Dreieich (DE)

(73) Assignee: Lenovo (United States) Inc., Morrisville, NC (US)

(21) Appl. No.: 19/279,377

(22) Filed: Jul. 24, 2025

(51) Int. Cl. H04W 72/0453; H04W 72/543; H04W 72/566

(52) U.S. Cl. CPC H04W 72/0453; H04W 72/543; H04W 72/566

(57) ABSTRACT

Various aspects of the present disclosure relate to dynamic radio bearer configuration. An apparatus, such as a user equipment (UE), receives first configuration information associated with a radio bearer. The first configuration information may indicate a set of configurations (i.e., protocol entity configurations) corresponding to numerous protocol entities or layers. Additionally, the UE may receive second configuration information associated with the radio bearer. The second configuration information may be received via downlink control information (DCI) or a medium access control (MAC) control element (MAC-CE), and may indicate one or more identifiers, where each identifier corresponds to one of the configurations. The UE may configure the radio bearer based on the second configuration information, for example, by applying the configuration corresponding to the indicated identifier.

### TECHNICAL FIELD

The present disclosure relates to wireless communications, and more specifically to dynamic radio bearer configuration.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or Cor AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A UE for wireless communication is described. The UE may be configured to, capable of, or operable to perform one or more operations as described herein. For example, the UE may be configured to, capable of, or operable to receive first configuration information associated with a radio bearer, where the first configuration information includes a set of multiple configurations for a set of multiple protocol entities; receive second configuration information associated with the radio bearer, where the second configuration information includes one or more identifiers, where each identifier of the one or more identifiers corresponds to a configuration of the set of multiple configurations; and configure the radio bearer based on the second configuration information.

A processor (e.g., a standalone processor chipset, or a component of a UE) for wireless communication is described. The processor may be configured to, capable of, or operable to perform one or more operations as described herein. For example, the processor may be configured to, capable of, or operable to receive first configuration information associated with a radio bearer, where the first configuration information includes a set of multiple configurations for a set of multiple protocol entities; receive second configuration information associated with the radio bearer, where the second configuration information includes one or more identifiers, where each identifier of the one or more identifiers corresponds to a configuration of the set of multiple configurations; and configure the radio bearer based on the second configuration information.

A method performed or performable by a UE for wireless communication is described. The method may include receiving first configuration information associated with a radio bearer, where the first configuration information includes a set of multiple configurations for a set of multiple protocol entities; receiving second configuration information associated with the radio bearer, where the second configuration information includes one or more identifiers, where each identifier of the one or more identifiers corresponds to a configuration of the set of multiple configurations; and configuring the radio bearer based on the second configuration information.

In some implementations of the UE, the processor, and the method described herein, to configure the radio bearer, the UE, the processor, and the method may further be configured to, capable of, operable to, performed to, or performable to configure a protocol entity associated with the radio bearer based on the configuration of the set of multiple configurations.

In some implementations of the UE, the processor, and the method described herein, the set of multiple configurations includes at least one full configuration and at least one delta configuration, where a full configuration includes a set of parameters for a protocol entity of the set of multiple protocol entities and a delta configuration includes one or more parameters for the protocol entity that differ from a previous full configuration.

In some implementations of the UE, the processor, and the method described herein, to configure the radio bearer, the UE, the processor, and the method may further be configured to, capable of, operable to, performed to, or performable to deactivate a first configuration of the set of multiple configurations and activate a second configuration of the set of multiple configurations for the radio bearer based on a criterion; and transmit an indication of the activated second configuration.

In some implementations of the UE, the processor, and the method described herein, the first configuration information further includes a set of multiple radio bearer configurations, each radio bearer configuration including one or more configurations of the set of multiple configurations, and the second configuration information includes an identifier of the one or more identifiers corresponding to a radio bearer configuration of the set of multiple radio bearer configurations, and where the radio bearer is configured based on the radio bearer configuration.

In some implementations of the UE, the processor, and the method described herein, the first configuration information further includes a set of multiple parameter sets for a functionality associated with the radio bearer, and where the radio bearer is configured based at least on part on a parameter set of the set of multiple parameter sets.

In some implementations of the UE, the processor, and the method described herein, the first configuration information further includes a set of multiple logical channel prioritization (LCP) parameter sets, where each LCP parameter set of the set of multiple LCP parameter sets corresponds to an identifier of the one or more IDs, and where the radio bearer, the UE, the processor, and the method may further be configured to, capable of, operable to, performed to, or performable to receive a signal indicating the identifier of an LCP parameter set; and apply the LCP parameter set to the radio bearer based on the signal.

In some implementations of the UE, the processor, and the method described herein, the set of multiple configurations includes at least one medium access control (MAC) parameter configuration, and where the one or more processors are further operable to cause the UE to receive a message indicating a MAC parameter configuration based on one or more service requirements.

In some implementations of the UE, the processor, and the method described herein, the UE, the processor, and the method may further be configured to, capable of, operable to, performed to, or performable to transmit assistance information indicating a preferred configuration of the set of multiple configurations.

In some implementations of the UE, the processor, and the method described herein, each protocol entity of the set of multiple protocol entities corresponds to at least one configuration of the set of multiple configurations.

In some implementations of the UE, the processor, and the method described herein, the set of multiple configurations includes at least one of an NE-controlled configuration, a UE-selectable configuration that is indicated to an NE, or a UE-selectable configuration that is not indicated to the NE.

In some implementations of the UE, the processor, and the method described herein, the second configuration information is received via a MAC-control element (MAC-CE) or downlink control information (DCI).

An NE (e.g., a base station) for wireless communication is described. The NE may be configured to, capable of, or operable to perform one or more operations as described herein. For example, the NE may be configured to, capable of, or operable to transmit first configuration information associated with a radio bearer, where the first configuration information includes a set of multiple configurations for a set of multiple protocol entities; and transmit second configuration information associated with the radio bearer, where the second configuration information includes one or more identifiers, where each identifier of the one or more identifiers corresponds to a configuration of the set of multiple configurations, and where the radio bearer is configured based on the second configuration information.

A processor (e.g., a standalone processor chipset, or a component of a NE) for wireless communication is described. The processor may be configured to, capable of, or operable to perform one or more operations as described herein. For example, the processor may be configured to, capable of, or operable to transmit first configuration information associated with a radio bearer, where the first configuration information includes a set of multiple configurations for a set of multiple protocol entities; and transmit second configuration information associated with the radio bearer, where the second configuration information includes one or more identifiers, where each identifier of the one or more identifiers corresponds to a configuration of the set of multiple configurations, and where the radio bearer is configured based on the second configuration information.

A method performed or performable by an NE (e.g., a base station) for wireless communication is described. The method may include transmitting first configuration information associated with a radio bearer, where the first configuration information includes a set of multiple configurations for a set of multiple protocol entities; and transmitting second configuration information associated with the radio bearer, where the second configuration information includes one or more identifiers, where each identifier of the one or more identifiers corresponds to a configuration of the set of multiple configurations, and where the radio bearer is configured based on the second configuration information.

In some implementations of the NE, the processor, and the method described herein, a protocol entity associated with the radio bearer is configured based on a configuration of the set of multiple configurations.

In some implementations of the NE, the processor, and the method described herein, the set of multiple configurations includes at least one full configuration and at least one delta configuration, and where a full configuration includes a set of parameters for a protocol entity of the set of multiple protocol entities and a delta configuration includes one or more parameters for the protocol entity that differ from a previous full configuration.

In some implementations of the NE, the processor, and the method described herein, the NE, the processor, and the method may further be configured to, capable of, operable to, performed to, or performable to receive an indication of an activated configuration of the set of multiple configurations.

In some implementations of the NE, the processor, and the method described herein, the NE, the processor, and the method may further be configured to, capable of, operable to, performed to, or performable to reconfigure the configuration of the radio bearer based on one or more quality of service (QoS) parameters associated with a QoS flow that is mapped to the radio bearer.

In some implementations of the NE, the processor, and the method described herein, the first configuration information further includes a set of multiple radio bearer configurations, each radio bearer configuration includes one or more configurations of the set of multiple configurations, and the second configuration information includes an identifier of the one or more identifiers corresponding to a radio bearer configuration of the set of multiple radio bearer configuration, and where the radio bearer is configured based on the radio bearer configuration.

In some implementations of the NE, the processor, and the method described herein, the first configuration information further includes a set of multiple parameter sets for a functionality associated with the radio bearer, and where the radio bearer is configured based at least on part on a parameter set of the set of multiple parameter sets.

In some implementations of the NE, the processor, and the method described herein, the first configuration information further includes a set of multiple LCP parameter sets, where each LCP parameter set of the set of multiple LCP parameter sets corresponds to an identifier of the one or more identifiers, and where the NE, the processor, and the method described herein, the NE, the processor, and the method may further be configured to, capable of, operable to, performed to, or performable to transmit a signal indicating the identifier of an LCP parameter set, where the LCP parameter set is applied to the radio bearer based on the signal.

In some implementations of the NE, the processor, and the method described herein, the set of multiple configurations includes at least one MAC parameter configuration, where the NE, the processor, and the method described herein, the NE, the processor, and the method may further be configured to, capable of, operable to, performed to, or performable to select a MAC parameter configuration based on one or more service requirements; and transmit a message indicating the selected MAC parameter configuration.

In some implementations of the NE, the processor, and the method described herein, the NE, the processor, and the method described herein, the NE, the processor, and the method may further be configured to, capable of, operable to, performed to, or performable to receive assistance information indicating a preferred configuration of the set of multiple configurations.

In some implementations of the NE, the processor, and the method described herein, each protocol entity of the set of multiple protocol entities corresponds to at least one configuration of the set of multiple configurations.

In some implementations of the NE, the processor, and the method described herein, the set of multiple configurations include at least one of an NE-controlled configuration, a UE-selectable configuration that is indicated to the NE, or a UE-selectable configuration that is not indicated to the NE.

In some implementations of the NE, the processor, and the method described herein, the second configuration information is transmitted via a MAC-CE or DCI.

### BRIEF DESCRIPTION OF THE DRAWINGS

FIG. 1 illustrates an example of a wireless communications system in accordance with aspects of the present disclosure.

FIGS. 2 and 3 illustrate examples of real-time transport protocol (RTP) header extensions in accordance with aspects of the present disclosure.

FIG. 4 illustrates an example of a mapping framework in accordance with aspects of the present disclosure.

FIG. 5 illustrates an example of a system architecture in accordance with aspects of the present disclosure.

FIGS. 6 and 7 illustrate examples of radio bearer configurations in accordance with aspects of the present disclosure.

FIGS. 8A through 9E illustrate examples of information elements (IEs) in accordance with aspects of the present disclosure.

FIG. 10 illustrates an example of a UE in accordance with aspects of the present disclosure.

FIG. 11 illustrates an example of a processor in accordance with aspects of the present disclosure.

FIG. 12 illustrates an example of an NE in accordance with aspects of the present disclosure.

FIG. 13 illustrates a flowchart of a method performed by a UE in accordance with aspects of the present disclosure.

FIG. 14 illustrates a flowchart of a method performed by an NE in accordance with aspects of the present disclosure.

### DETAILED DESCRIPTION

In a wireless communications system, a UE and an NE (e.g., a base station, gNB) may support wireless communication (e.g., reception and/or transmission of wireless communication) using time-frequency resources. In some wireless communication systems, such as 5G systems, the UE and the NE may establish a logical connection, such as a QoS flow that supports a particular QoS based on one or more QoS characteristics, such as latency, reliability, and throughput. QoS flow management may be predominantly based on static configurations. However, it may be desirable to enhance QoS flow resource types and management capabilities beyond a fixed QoS model, in order to support a more dynamic and adaptive QoS flow framework. Such a framework may be capable of accommodating not only fluctuating network conditions, but also evolving requirements of adaptive applications.

Additionally, to support dynamically changing QoS requirements, for example, via an adaptive or flexible QoS flow framework, one or more data radio bearer (DRB) configurations may be updated. For example, if a bit rate of a QoS flow changes, a guaranteed bit rate (GBR) of a corresponding DRB may also be adjusted accordingly. Consequently, a prioritized bit rate (PBR) configuration for a corresponding logical channel (LCH) may also be updated. Failure to update the PBR configuration (e.g., if a PBR remains high while rate control reduces the actual data rate) may lead to resource misallocation and starvation of lower-priority LCHs, further resulting in network congestion and reduced signaling throughput. In some cases, a radio access network (RAN) (e.g., base station, gNB) may establish multiple radio bearers for a dynamic QoS flow based on the range of QoS requirements configured for the QoS flow. The mapping of the dynamic QoS flow to a set of multiple DRBs may be adapted or switched in response to changing network conditions and application requirements. In some other cases, an NE may use a radio resource control (RRC) reconfiguration procedure to adapt layer 2 (L2) configurations and parameters, which may be signaling and processing intensive.

Aspects of the present disclosure are described in the context of a wireless communications system, and include implementations that provide procedures for dynamic radio bearer configurations. The described techniques facilitate dynamic L2 configuration updates, for example, for the service data adaptation protocol (SDAP) entity (i.e., layer), the packet data convergence protocol (PDCP) entity (i.e., layer), and the radio link control (RLC) entity (i.e., layer), without relying on signaling-heavy RRC reconfiguration procedures. Specifically, the described techniques support a dynamic radio bearer for which an L2 configuration or parameter may be dynamically adapted (e.g., adjusted, updated, modified) according to traffic characteristics (e.g., latency reliability, bit rate, capacity, etc.) of an application. Such a dynamic radio bearer may enable adaptation of QoS parameters, such as priority levels, latency targets, throughput requirements, and so forth, in response to a changing network status and application behavior.

In some implementations, a radio bearer (e.g., a dynamic radio bearer) may be established between a UE and an NE (e.g., a gNB), which may allow for switching between different radio bearer configurations without involving a complete RRC reconfiguration procedure. The NE may preconfigure a set of different configurations or parameters for each L2 protocol entity supported by the UE (e.g., SDAP, PDCP, and RLC entities). A radio bearer configuration may include one or more protocol entity configurations (e.g., a modular bearer concept).

Additionally, or alternatively, the NE may configure a set of distinct radio bearer configurations, each radio bearer configuration including one or more of the protocol entity configurations. The NE may then instruct the UE to establish one of the radio bearer configurations. In some examples, the NE may configure the UE to establish (e.g., enable, apply) a radio bearer configuration by explicitly signaling an index corresponding to the selected radio bearer configuration. During reconfiguration of an existing radio bearer, the NE may transmit both an identifier of the radio bearer and the index of the radio bearer configuration to be applied to the radio bearer.

Additionally, or alternatively, the NE may preconfigure a set of configurations or parameter sets associated with a specific L2 functionality (e.g., of an SDAP, PDCP, or RLC entity) and/or UE feature for a given radio bearer. The UE may apply one of the configurations or parameter sets to the corresponding radio bearer as directed by the NE. To facilitate dynamic updates of such configurations or parameter sets without triggering a signaling-intensive RRC reconfiguration procedure, the NE may transmit an indication to the UE specifying which preconfigured configuration or parameter set to apply for a corresponding functionality.

Specifically, the UE may receive first configuration information associated with a radio bearer. The first configuration information may indicate a set of configurations (i.e., protocol entity configurations) corresponding to numerous protocol entities or layers, such as the SDAP, PDCP, and RLC entities. Additionally, the UE may receive second configuration information associated with the radio bearer. The second configuration information may be received via DCI or MAC-CE signaling, and may indicate one or more identifiers (e.g., indices), where each identifier (e.g., index) corresponds to one of the configurations. The UE may configure the radio bearer based on the second configuration information, for example, by applying the configuration corresponding to the indicated identifier. By performing the described techniques, a wireless communications system can benefit from reduced signaling overhead, and reduced latency, among other improvements. For example, the described techniques may utilize DCI and MAC-CE signaling to dynamically configure radio bearers, which may reduce signaling and processing overhead over systems that use RRC reconfiguration procedures.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

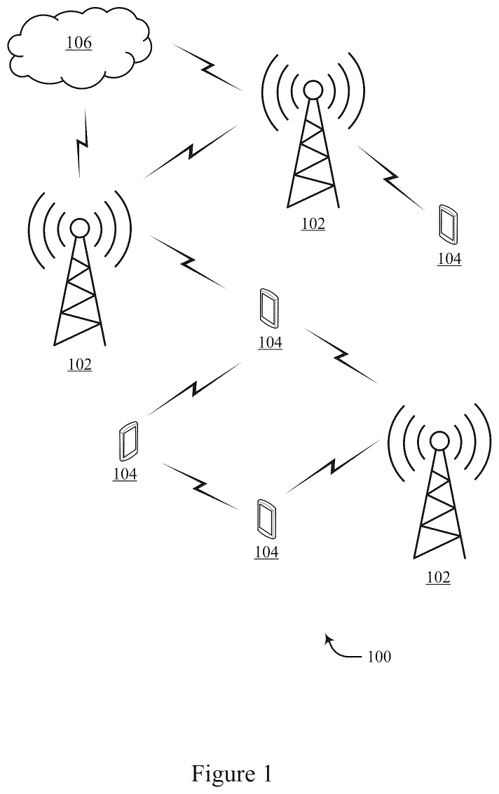

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, a UE 104 may receive first configuration information associated with a radio bearer. The first configuration information may indicate a set of configurations (i.e., protocol entity configurations) corresponding to numerous protocol entities or layers, such as the SDAP, PDCP, and RLC entities. Additionally, the UE 104 may receive second configuration information associated with the radio bearer. The second configuration information may be received via DCI or MAC-CE signaling, and may indicate one or more identifiers (e.g., indices), where each identifier (e.g., index) corresponds to one of the configurations. The UE 104 may configure the radio bearer based on the second configuration information, for example, by applying the configuration corresponding to the indicated identifier.

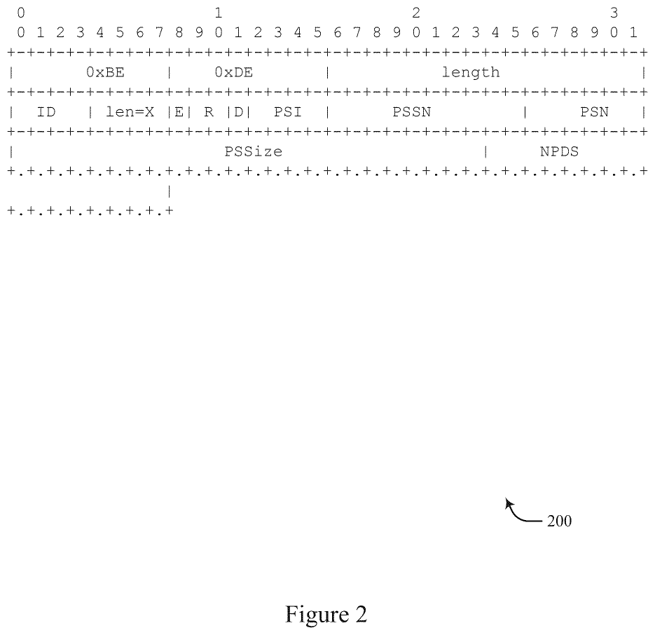

FIG. 2 illustrates an example of an RTP header extension 200 in accordance with aspects of the present disclosure. In some implementations, the RTP header extension 200 may be used to transmit PDU set information.

5G systems may support extended reality (XR) applications and services where multimedia (e.g., audiovisual) flows are multiplexed under a single network application session (i.e., a 5-tuple containing a source IP address, a destination IP address, a source network port, a destination network port, and a protocol number as an ID). For example, an XR application based on Web real-time communication (WebRTC) or on an RTP/secure RTP (SRTP) protocol stack may include one or more video streams and audio streams multiplexed with control and feedback metadata and application metadata (e.g., user pose information, user input actions, and so forth) over a single application data network session. Although XR is used as a reference use case or a family of applications associated with the techniques described herein, the described techniques are generally applicable and may be embodied by different types of transport and network protocol stacks (e.g., quick user datagram protocol (UDP) Internet Connections (QUIC), WebRTC, WebTransport, and so forth).

XR applications may include any combination of virtual reality (VR), augmented reality (AR), and mixed reality (MR). VR is a rendered version of a delivered audiovisual scene. The rendering may be designed to mimic the visual and audio sensory stimuli of the real world as naturally as possible to an observer or user as the user moves within the limits defined by an application. In some examples of VR, the user may wear a head mounted display (HMD) to replace the user's field of view with a simulates visual component. Additionally, or alternatively, the user may wear headphones that provide the user with accompanying audio. Some form of head and motion tracking of the user in VR may be utilized to allow the simulated audio and visual components to be updated, ensuring that, from the user's perspective, items and sound sources remain consistent with the user's physical movements. In some implementations, the user may interact with a VR simulation in additional ways.

AR applications provide a user with additional information or artificially generated (e.g., artificial intelligence (AI) or machine learning generated) items or content overlaid on the user's current environment. Such additional information or content may be visual and/or audible. The user's observation of their current environment may be direct, with no intermediate sensing, processing, and rendering, or indirect, where the user's perception of their environment may be relayed vis sensors for enhancement or processing. MR is an advanced form of AR where some virtual elements may be inserted into a physical scene with the intent to provide an illusion that such elements are part of the real scene.

In this way, XR may refer to all real and virtual combined environments and human-machine interactions generated by computer technology and wearables. XR includes representative forms such as VR, AR, MR, and the areas interpolated among them, as described herein. The level of virtuality for an XR application may range from partially sensory inputs to fully immersive VR, for example. A key aspect of XR is the extension of human experiences, particularly relating to a user's senses of existence (e.g., represented by VR) and the acquisition of cognition (e.g., represented by AR).

Some systems include an XR media (XRM) feature at the CN level, which may support a PDU set to handle QoS requirements of XRM applications and streams with improved granularity. A PDU set may include one or more PDUs carrying a payload of one unit of information generated at the application level (e.g., a frame or video slice for XRM services). In some implementations, all PDUs in a PDU set may be utilized by the application entity to use the corresponding unit of information. Alternatively, the application entity may still recover parts or all of the unit of information when some PDUs are missing from the PDU set.

Additionally, the PDU set may be associated with QoS requirements such as a PDU set delay budget (PSDB) and a PDU set error rate (PSER). The PSDB may define an upper bound for a time that a PDU set may be delayed between a UE and an N6 termination point at the user plane function (UPF). The PSDB applies to a downlink PDU set received by the UPF over the N6 interface and to an uplink PDU set sent by the UE. The PSER may define an upper bound for the rate of PDU sets (e.g., a set of IP packets constituting a PDU set) that have been processed by the sender of a link layer protocol (e.g., RLC in RAN of a 3GPP access), but where all of the PDUs in the PDU set are unsuccessfully delivered by the corresponding receiver to the upper layer (e.g., PDCP in RAN of a 3GPP access). The PSER may be used to determine an upper bound for a rate of non-congestion-related packet losses.

Some systems support PSU set, QoS-integrated handling, in which a PDU session anchor (PSA) UPF identifies PDUs that belong to PDU sets and determines, for each PDU set, PDU set information below that is sent to a next generation (NG)-RAN via a general packet radio service (GPRS) tunneling protocol, user plane (GTP-U) header. The PSU set information may include one or more of a PDU set sequence number, an indication of an end PDU of the PDU set, a PDU sequence number within a PDU set, a PDU set size in bytes, or a PDU set importance, which identifies the relative importance of a PDU set compared to other PDU sets within a QoS flow. The NG-RAN may use the PDU set information for PDU set-based QoS handling, as described herein.

In some implementations, the NG-RAN may use priority levels across QoS flows and the PDU set importance within a QoS flow for PDU set level packet discarding in the presence of congestion. In some other implementations, the PSA UPF may identify PDUs that belong to PDU sets. If the UPF receives a PDU that does not belong to a PDU set based on a protocol description for PDU set identification (e.g., had not been marked with PDU set information by the application server (AS)), then the UPF may still map the PDU to a PDU set and determine the corresponding PDU set information as described herein. This ensures that for a QoS flow with a PDU set enabled, all PDUs belong to a PDU set. If the PSA UPF receives a PDU that does not belong to a PDU set, the UPF may determine a PDU set importance value based on a pre-configuration or based on a default PDU set importance signaled by an AS or an application function (AF).

In some implementations, the AS may transmit the PDU set information via the RTP header extension 200, which may be a one-byte RTP header extension for the marking of PDU sets and end of bursts. The RTP header extension 200 may include a 1-bit field, E, that indicates the end PDU of the PDU set. This field may be a flag set to 1 to represent the last PDU of the PDU set or set to 0 to represent all other PDUs of the PDU set. Additionally, or alternatively, the RTP header extension 200 may include a 2-bit field, R, that is reserved for future use. Additionally, or alternatively, the RTP header extension 200 may include a 1-bit field, D, that indicates an end of a data burst. This field may be set to a non-zero value when the end of the data burst is present and set to a value of 0 otherwise. Additionally, or alternatively, the RTP header extension 200 may include a 4-bit, PDU set importance (PSI) field that indicates the importance of a PDU set compared to other PDU sets within a same QoS flow. Lower values in the PSI field may indicate a higher importance PDU set, with the highest importance PDU set represented by a value of 0 and the lowest importance PDU set represented by a value of 15.

Additionally, or alternatively, the RTP header extension 200 may include a 10-bit, PDU set sequence number (PSSN) field that encodes a sequence number of the PDU set to which a current PDU belongs. The PSSN field may act as a 10-bit numerical identifier for the PDU set, and may wrap around at 1023. Additionally, or alternatively, the RTP header extension 200 may include a 6-bit, PDU sequence number (PSN) field that indicates a sequence number of the current PDU within the PDU set. The PSN field may be set to 0 for a first PDU in the PDU set and incremented monotonically for every other PDU in the PDU set in order of transmission from the sender. The PSN field may wrap around 63. Additionally, or alternatively, the RTP header extension 200 may include a 24-bit PDU set size (PSSize) field. The PSSize field may indicate a total size of all PDUs of the PDU set to which the current PDU belongs. The PSSize field may be optional and subject to a session description protocol (SDP) signaling offer/answer negotiation, where the AS may indicate whether the AS will be able to provide the size of the PDU set for a given RTP stream. If not enabled, the PSSize field may not be present in the RTP header extension 200. If the PSSize field is enabled but the AS is unable to determine the PDU set size for a particular PDU set, the PSSize field may be set to a value of 0 for all PDUs of that PDU set. The PSSize field may indicate a size of a PDU set including RTP, UDP, and IP header encapsulation overhead of its corresponding PDUs. The PSSize field may be expressed in bytes.

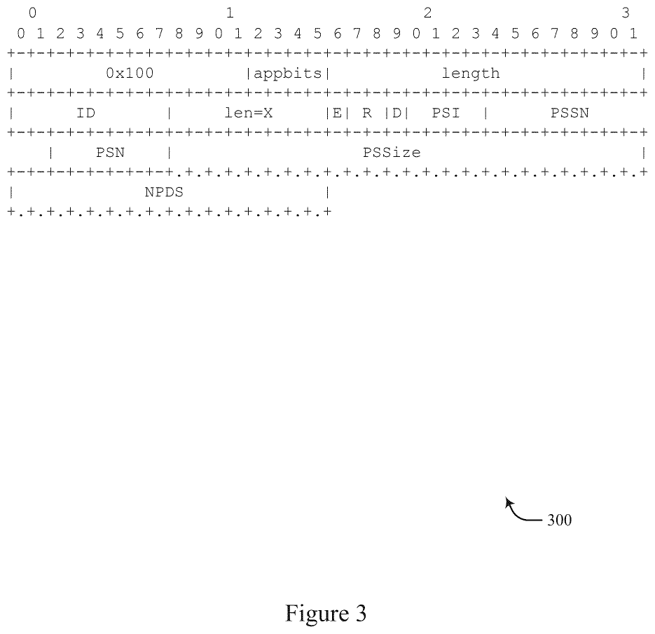

FIG. 3 illustrates an example of an RTP header extension 300 in accordance with aspects of the present disclosure. In some implementations, the RTP header extension 300 may be used to transmit PDU set information. In contrast to the RTP header extension 200 of FIG. 2, the RTP header extension 300 may be a two-byte header extension for the marking of PDU sets and end of bursts.

The RTP header extension 300 may include a 1-bit field, E, that indicates the end PDU of the PDU set. This field may be a flag set to 1 to represent the last PDU of the PDU set or set to 0 to represent all other PDUs of the PDU set. Additionally, or alternatively, the RTP header extension 300 may include a 2-bit field, R, that is reserved for future use. Additionally, or alternatively, the RTP header extension 300 may include a 1-bit field, D, that indicates an end of a data burst. This field may be set to a non-zero value when the end of the data burst is present and set to a value of 0 otherwise. Additionally, or alternatively, the RTP header extension 300 may include a 4-bit, PDU set importance (PSI) field that indicates the importance of a PDU set compared to other PDU sets within a same QoS flow. Lower values in the PSI field may indicate a higher importance PDU set, with the highest importance PDU set represented by a value of 0 and the lowest importance PDU set represented by a value of 15.

Additionally, or alternatively, the RTP header extension 300 may include a 10-bit, PDU set sequence number (PSSN) field that encodes a sequence number of the PDU set to which a current PDU belongs. The PSSN field may act as a 10-bit numerical identifier for the PDU set, and may wrap around at 1023. Additionally, or alternatively, the RTP header extension 300 may include a 6-bit, PDU sequence number (PSN) field that indicates a sequence number of the current PDU within the PDU set. The PSN field may be set to 0 for a first PDU in the PDU set and incremented monotonically for every other PDU in the PDU set in order of transmission from the sender. The PSN field may wrap around 63. Additionally, or alternatively, the RTP header extension 300 may include a 24-bit PDU set size (PSSize) field. The PSSize field may indicate a total size of all PDUs of the PDU set to which the current PDU belongs. The PSSize field may be optional and subject to a session description protocol (SDP) signaling offer/answer negotiation, where the AS may indicate whether the AS will be able to provide the size of the PDU set for a given RTP stream. If not enabled, the PSSize field may not be present in the RTP header extension 300. If the PSSize field is enabled but the AS is unable to determine the PDU set size for a particular PDU set, the PSSize field may be set to a value of 0 for all PDUs of that PDU set. The PSSize field may indicate a size of a PDU set including RTP, UDP, and IP header encapsulation overhead of its corresponding PDUs. The PSSize field may be expressed in bytes.

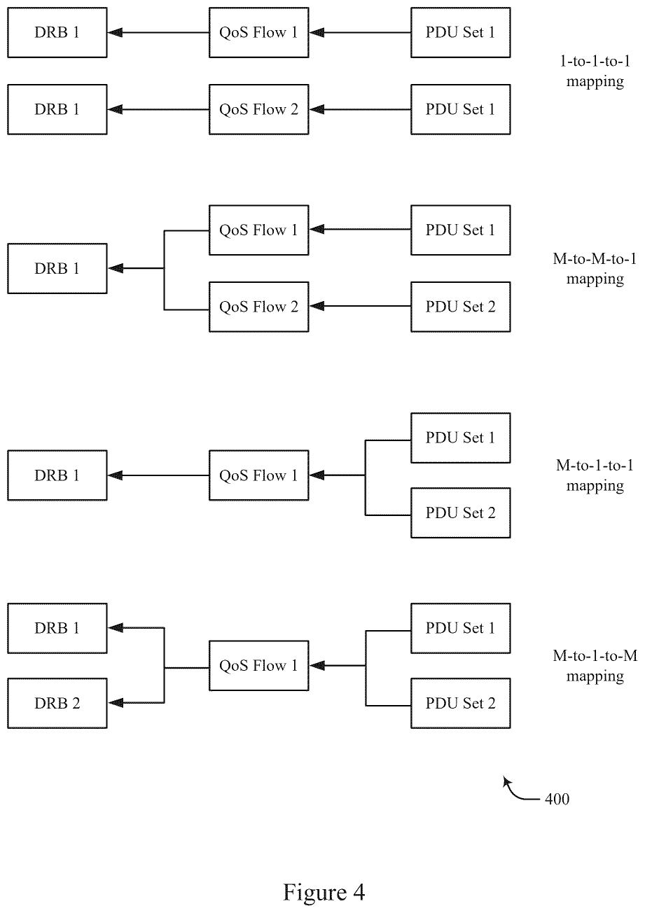

FIG. 4 illustrates an example of a mapping framework 400 in accordance with aspects of the present disclosure. In the example of FIG. 4, the mapping framework 400 may support PDU set-to-QoS flow-to DRB mappings, including a 1-to-1-to-1 mapping, an M-to-M-to-1 mapping, an M-to-1-to-1 mapping, and an M-to-1-to-M mapping. The mapping framework 400 may be part of a PDU set-aware QoS handling framework.

In some examples, reciprocal processing may be applicable to uplink communications, where the UE may take the role of UPF packet inspection, which includes inspecting packets, determining which packets belong to a PDU set, and signaling a PDU set to the RAN accordingly. The RAN may use the signaled PDU for scheduling and resource allocation corresponding to an associated DRB fulfilling capable of fulfilling PDU set QoS requirements (i.e., PSDB and PSER). The low-level signaling mechanism associated with the uplink UE-to-RAN information passing may be up to the specification and implementations of RAN signaling procedures.

Based on QoS flow mappings, including the mapping framework 400, and RAN procedures, several alternative PDU set-to-QoS flow-to-DRB mappings may be utilized given two distinct PDU sets with different PDU set attributes, such as PDU set importance. In the mapping framework 400, two PDU sets of different importance and characteristics may be mapped to QoS flows and DRBs. For example, a PDU set 1 may be of high importance with strict QoS requirements (i.e., PSDB, PSER, etc.) and a PDU set 2 may be of lower importance with potentially lower QoS requirements (i.e., PSDB, PSER, etc.) than the PDU set 1. In such cases, the PDU set-to-QoS flow-to-DRB mapping may be a 1-to-1-to-1 mapping, an M-to-M-to-1 mapping, an M-to-1-to-1 mapping, or an M-to-1-to-M mapping based on QoS flow policies and L2 RAN procedures.

In the 1-to-1-to-1 mapping, the separation of QoS flows and DRBs may be complete between high and low importance PDU sets, which optimizes radio and network resources on a per-PDU set basis. For example, the PDU set 1 may be mapped to a QoS flow 1 and a DRB 1, and the PDU set 2 may be mapped to a QoS flow 2 and a DRB 2.

In the M-to-M-to-1 mapping, the separation between the high and low importance PDU sets may be performed at a QoS flow level, where the same DRB is mapped to and used for the over-the-air transmission of both PDU sets. For example, the PDU set 1 may be mapped to a QoS flow 1 and a DRB 1, and the PDU set 2 may be mapped to the QoS flow 2 and the DRB 1. Such cases may lead to overprovisioning of radio resources for low importance PDU sets, however a lower overhead related to RAN complexity and management.

In the M-to-1-to-1 mapping, there may be no separation between the QoS flows and DRBs of different importance PDU sets. In addition, the higher-importance PDU set QoS requirements may be prioritized in handling of the QoS management across both the CN and the RAN. For example, the PDU set 1 may be mapped to a QoS flow 1 and a DRB 1, and the PDU set 2 may be mapped to the QoS flow 1 and the DRB 1. Such cases may lead to the overprovisioning of resources for low importance PDU sets in both CN and RAN implementations, but may be associated with a lower overhead and control within 5G QoS frameworks.

In the M-to-1-to-M mapping, there may be no separation of QoS flows for PDUs with different importance levels, however, distinct DRBs may be used to cater to individual requirements of the distinct PDU importance levels. For example, the PDU set 1 may be mapped to a QoS flow 1 and a DRB 1, and the PDU set 2 may be mapped to the QoS flow 1 and a DRB 2. Such cases may compromise QoS flow management complexity and use PDU set information to filter the PDU sets on different DRBs in order to better match QoS requirements at a RAN level and optimize resource allocation according to individual PDU set needs.

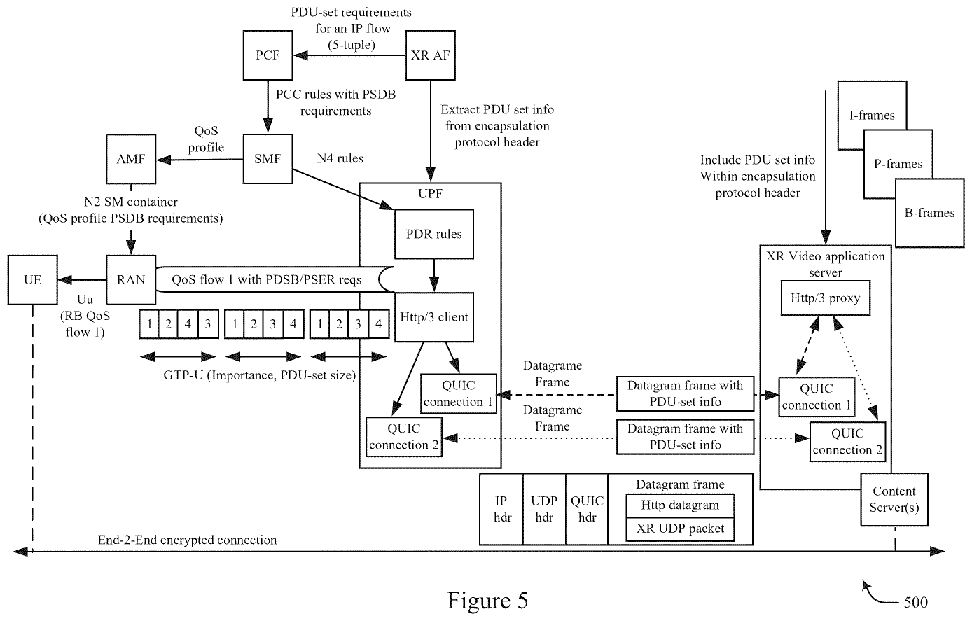

FIG. 5 illustrates an example of a system architecture 500 in accordance with aspects of the present disclosure. The system architecture 500 may allow a CN to be aware of PDU set information when an end-to-end XRM application is fully encrypted. For example, the system architecture 500 may support the use of QUIC (e.g., a QUIC tunnel) between a UPF and a AS, including within headers of a hypertext transfer protocol (HTTP) datagram, metadata that includes PDU set information. The UPF may extract the PDU set information metadata and include the PDU set within a GTP-U header toward the RAN.

In some implementations, an AF may provide (e.g., send, transmit, enable) QoS requirements that a 5G network (e.g., a policy control function (PCF)) may translate into specific QoS characteristics (i.e., 5G QoS parameters). The QoS characteristic may be associated with 5QI, where each 5QI may have specific traffic characteristics (e.g., specific packet delay requirements, packet error rates, and maximum data burst volumes). Several standardized 5QI support services such as conversational voice, video, real-time gaming, and so forth. When the RAN receives a packet (on the downlink) identified by a specific 5QI, the RAN may handle the packet according to the specific traffic characteristics of the 5QI.

However, some QoS frameworks may be too slow to adapt to applications that have dynamically changing traffic characteristics. For example, video media may involve transmission of sudden bursts of traffic (e.g., when a scene changes). In some systems, the RAN node may use the same QoS characteristics regardless of the size of the burst, resulting in latency and high overhead. In some other implementations, traffic characteristics of XR services may change dynamically. For example, the size of a media segment may vary dynamically. For example, when a user moves a progress bar on a streaming video, more bandwidth may be needed to buffer an initial set of video frames to allow the streaming application to buffer enough data to support smooth video playback. In another example, the size of a data burst for an XR service may vary dynamically during video scene changes. In such cases, an encoder may create a new video I-frame where the packet size may be considerably higher than a packet size of a previous frame.

Since a 5QI is associated with specific traffic characteristics (e.g., a specific maximum the data burst volume), the RAN may lack flexibility to handle different packets differently when corresponding traffic characteristics change dynamically. Accordingly, in some systems, an AS may transmit an indication of a traffic burst received at a UPF and forwarded to the RAN via GTP-U signaling. The RAN may adjust its scheduling resources according to the traffic burst size. However, such systems are inflexible because how the RAN node adjusts its scheduling resources may be implementation-specific and inconsistent across similar traffic flows with similar traffic characteristics.

In some systems, an AF may indicate requirements to boost a data rate for an application session providing additional QoS requirements, where the network may configure two QoS flows, one with default QoS requirements and one with higher QoS requirements. The AS may indicate which packet needs a higher QoS (within metadata over N6), and the UPF may route that packet over the higher QoS flows. Such systems, however, may waste resources as the RAN maintains resources for the higher QoS flows even when there are no packets currently routed over such flows.

For some radio access technologies beyond 5G, including 5G-A networks, service provisioning for high bandwidth, interactive, and adaptive applications (e.g., XR and immersive experience) is required to ensure that applications run at high quality of experience (QoE) levels and/or that the network knows more information about application requirements, including application adaptation capabilities.

Fixed (i.e., hard) QoS metrics for applications that are capable to adapt may create challenges in effectively distributing network resources across users and accommodating capacity needs given dynamic network conditions (e.g., congested or non-congested networks). However, some QoS flow types in 5G QoS frameworks may rely on fixed QoS metrics and require reconfiguration over control plane interactions that may be too slow to leverage application adaptation potential and/or requirements. Moreover, the fixed allocation of resources may overprovision network resources and, in some cases (e.g., or loaded cells), prohibitively use the network, affecting network performance and multiple users simultaneously. Table 1 summarizes some 5G QoS flow resource types and their relation to QoS metrics and parameters such as bit rate, delay and latency (e.g., packet delay budget (PDB)), and reliability (e.g., packet error rate (PER)).

TABLE 1

| QoS metric | Non-GBR QoS flow | GBR QoS flow | Delay-critical GBR |
|---|---|---|---|
| Bit rate metric | No bit rate guarantees | Bit rate guaranteed | Bit rate guaranteed |
| (bits/second QoS | (best effort bandwidth | | Burst peak rate |
| parameter) | allocation) | | guaranteed up to |
| | | | maximum data burst |
| | | | volume |
| Latency metric (PDB | Should not exceed | Soft upper bound, | Strict upper bound, |
| parameter) | PDB parameter by >2% | shall not exceed PDB | shall not exceed PDB |
| | of packets at | by >2% of packets | by allowed PER |
| | uncongested cell | | |

| | | |
|---|---|---|
| Reliability metric | Packets exceeding PDB (i.e., congested | Packets exceeding |
| (PER parameter) | network cell) do not count to PER | PDB count to PER |

(when the configured
maximum data burst
volume or bit rate are
not exceeded)

In some 5G systems, QoS flow management may be based on static configurations. However, it is important to enhance QoS flow resource types and management capabilities beyond fixed QoS models and implement more dynamic, adaptive QoS flow frameworks. Such a framework may be capable of accommodating not only fluctuating network conditions but also the evolving needs of adaptive applications (e.g., minimum bit rate versus target bit rate, maximum PDB/PER versus target PDB/PER, etc.).

In some implementations, resource management efficiency may be improved based on dynamically changing traffic characteristics, such as time-to-next-burst and burst size, particularly in the context of media services and applications. Media applications often exhibit dynamically varying traffic patterns, such as variable bit rates or periodic bursts, which require effective management to enable optimized use of QoS and XR features. Some other traffic characteristics specific to media services may exhibit similar dynamics and may be utilized by a UE to enable energy-efficient behaviors such as activating sleep modes in the modem during transmission gaps.

Improving QoS flow management may be relative to numerous use cases. For example, in variable bitrate encoding, increasing adoption of variable bitrate (VBR) encoders may lead to fluctuating traffic profiles. In scenarios where an encoder overshoots (e.g., during complex media scenes), the system may leverage data burst size markings to trigger data boosts in the downlink. In another example, applications such as live streaming may be associated with periodic media traffic, where the applications may request segments at regular time intervals (e.g., every 2 seconds) or transmit RTP packets in alignment with video frame rates. This periodicity may be exploited for power savings and improved scheduling, using defined signaling.

In another example, real-time media services and other real-time communications may frequently transmit packet bursts when a frame is ready, resulting in transient high bitrates. Such services may benefit from data burst indication mechanisms for better traffic adaptation. In another example, QoS requirements for media services, such as instantaneous bit rate, error rate, and latency, may guide a more effective use of 5G QoS and XR capabilities, including recommendations for dynamic adaptation based on instantaneous needs. In another example, multi-modals services (e.g., inter-stream relationships between audio, video, and haptic feedback) may optimize support for multimodal applications within a network.

Improved identification and characterization of dynamically changing traffic patterns in media applications may include specific signaling mechanisms through application programming interfaces (APIs) or in-band signaling. Some QoS frameworks may assume static QoS parameters that are maintained once a QoS flow is established. While sufficient for applications with predictable traffic, such frameworks may be inadequate for applications and services with variable or burst-based traffic. For instance, bandwidth requirements for video streaming may fluctuate significantly, where large P-frames may require high throughput under strict latency constraints and smaller I-frames require lower throughput. To accommodate such variability, networks may configure a QoS flow capable of meeting a highest expected bandwidth demand, which may result in inefficient resource utilization during low-traffic periods.

Additionally, to support dynamically changing QoS requirements, for example, via an adaptive or flexible QoS flow framework, DRB configurations may also be updated. For example, if a bit rate of a QoS flow changes, a GBR of the associated DRB may also be adjusted accordingly. Consequently, a PBR configuration for a corresponding LCH may also be updated. Failure to update the PBR configuration (e.g., if a PBR remains high while rate control reduces the actual data rate) may lead to resource misallocation and starvation of lower-priority LCHs, further resulting in network congestion and reduced signaling throughput. In some cases, a RAN may create multiple radio bearers for a dynamic QoS flow based on the range of QoS requirements configured for the QoS flow. The mapping of the dynamic QoS flow to a set of multiple DRBs may be adapted or switched in response to changing network conditions and application requirements. In some other cases, an NE may use an RRC reconfiguration procedure to adapt L2 configurations and parameters, which may be signaling and processing intensive.

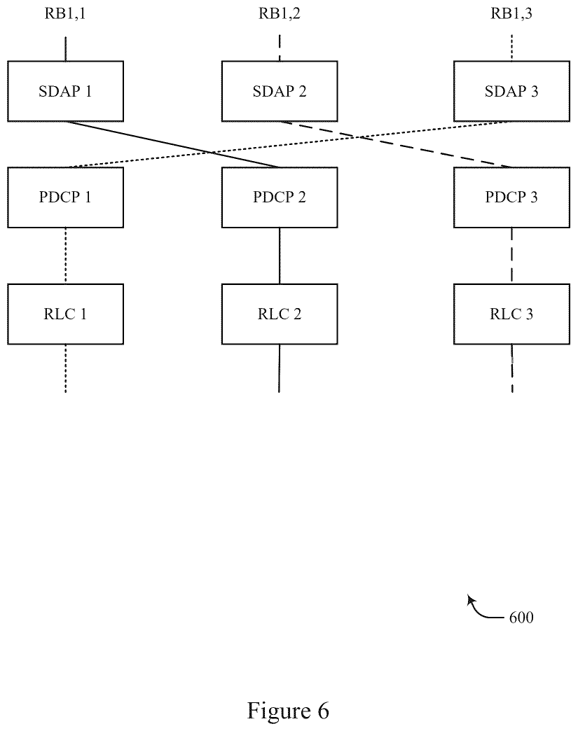

FIG. 6 illustrates an example of a radio bearer configuration 600 in accordance with aspects of the present disclosure. The radio bearer configuration 600 illustrates three, non-limiting variations of radio bearer configurations for a dynamic radio bearer (e.g., a dynamic DRB).

In some implementations, a radio bearer (e.g., a dynamic radio bearer) may be established between a UE and an NE, which may allow for switching between different radio bearer configurations without performing a complete RRC reconfiguration procedure. In some implementations, the radio bearer may include a set of L2 or layer 3 (L3) protocol entity or layer configurations. For example, the radio bearer include an RRC configuration, an SDAP configuration, a PDCP configuration, an RLC configuration, or any combination thereof. In some examples, a radio bearer configuration may indicate parameters for different protocol entities (e.g., PDCP, SDAP, or RLC entities) for the radio bearer.

In some implementations, a set of different configurations may be configured (e.g., preconfigured) for each of the L2 protocol entities or layers. For example, a UE may receive first configuration information associated with a radio bearer indicating a set of multiple SDAP and PDCP configurations. In some examples, the NE may configure two different PDCP configurations. with different PDCP related parameters (e.g., different PDCP discardTimer values or different PDU set related parameters for the two PDCP entity configurations). In another example, the NE may configure a set of RLC entity configurations, where each RLC entity configuration includes one or more different LCH configurations (e.g., logical channel prioritization (LCP)-related configurations) or one or more RLC-related timer configurations.

In some implementations, the NE may configure the radio bearer by configuring a combination of different configurations for different protocol entities. For example, the NE may configure a radio bearer configuration including a first SDAP configuration (out of a set of three different SDAP entity configurations), a second PDCP configuration (out of a set of three different PDCP entity configurations), and a second RLC entity configuration (out of a set of three different RLC entity configurations). To enable a highest degree of flexibility, the NE may configure a combination of different protocol entity configurations. For example, if the NE has three different configurations for each protocol entity (e.g., three different SDAP entity configurations, three different PDCP entity configurations, and three different RLC configurations), the NE may configure nine different radio bearer configurations according to the described techniques. Accordingly, a radio bearer may be a combination of different protocol entity configurations, also referred to herein as a modular bearer concept.

In some implementations, each protocol entity configuration may be uniquely identified by some identifier, such as an index. In the example of FIG. 6, each of the three distinct configurations for each of the SDAP, PDCP, and RLC entities may be mapped to a corresponding index, enabling efficient identification and selection by the UE. For example, a radio bearer (RB1) may support three radio bearer configurations. A first radio bearer configuration with an index RB1,1 may have an SDAP configuration 1, SDAP 1 (e.g., first of three SDAP entity configurations with an index 1), a PDCP configuration 2, PDCP 2 (e.g., second of three PDCP entity configurations with an index 2), and an RLC configuration 2, RLC 2 (e.g., second of three RLC entity configurations with an index 2). A second radio bearer configuration with an index RB1,2 may have an SDAP configuration 2, SDAP 2 (e.g., second of three SDAP configurations with an index 2), a PDCP configuration 3, PDCP 3 (e.g., third of three PDCP configurations with an index 3), and an RLC configuration 3, RLC 3 (e.g., third of three RLC configurations with an index 3). A third radio bearer configuration with an index RB1,3 may have an SDAP configuration 3, SDAP 3 (e.g., third of three SDAP configurations with an index 3), a PDCP configuration 1, PDCP 1 (e.g., first of three PDCP configurations with an index 1), and an RLC configuration 1, RLC 1 (e.g., first of three RLC configurations with an index 1). In this way, each individual configuration for a protocol entity may be mapped to a corresponding index. In addition, the three variations of radio bearer configurations may be flexibly applied to the same radio bearer (e.g., RB1) to meet specific performance and service requirements.

When an NE configures or establishes a radio bearer (e.g., a DRB), the NE may communicate the desired protocol entity configurations to the UE by signaling the respective indices. In this way, the NE may transmit (e.g., send) a radio bearer configuration message (e.g., second configuration information) including a set of indices, each index referencing a specific protocol entity configuration previously indicated in the first configuration information. Such an approach may enable a flexible and efficient mechanism for defining radio bearer characteristics.

In some examples, the NE may transmit a radio bearer configuration message (e.g., the second configuration information) or a radio bearer reconfiguration message (e.g., to update or change one or more protocol entity configurations) via MAC-CE signaling or physical layer signaling, such as DCI.

In some implementations, the set of protocol entity configurations may include at least one full (e.g., complete) configuration (e.g., a first configuration and at least one delta configuration (e.g., a second configuration). A delta configuration may include only parameters that differ from the full configuration, that is, the delta relative to a last known full configuration. Put another way, the parameters in the delta configuration effectively overwrite the parameters in the last known full configuration. Additionally, delta signaling enables efficient control information transmissions between the NE and a UE. Unlike conventional signaling, which involves the exchange of a full set of configuration parameters (i.e., a full configuration) regardless of any changes to the parameters, the delta signaling enables the NE to signal just parameters that are updated. This approach reduces signaling overhead and enhances spectral efficiency. In some implementations, delta configurations at an L2 protocol entity define only modified parameters in relation to the full configuration (e.g., a baseline configuration). For instance, an initial configuration, such as the PCDP configuration 1, may represent a full configuration including all relevant PDCP parameters. Subsequent configurations for the PDCP entity (e.g., PDCP configuration 2 and PDCP configuration 3) may then reference this baseline configuration with only changed parameters conveyed via delta signaling.

In some implementations, the UE may receive one or more delta configurations during an initial radio bearer establishment procedure. This may apply in cases where at least one of the protocol entity configurations is provided as a delta, such as PDCP configuration 2 or PDCP configuration 3. In such cases, the UE may determine the complete radio bearer configuration by referencing the corresponding full configuration (e.g., PDCP configuration 1) and applying any changes or modifications to parameters that are specified in a delta configuration. This enables efficient signaling while ensuring that the UE accurately reconstructs the full set of parameters required for radio bearer establishment and setup.

In some implementations, to reconfigure a radio bearer, the NE may transmit an indication of an identifier or an index of the specific protocol entity configuration to be applied. The NE may transmit such an indication (e.g., a reconfiguration message) via a MAC-CE or DCI. Based on receiving the indication, the UE may update only the protocol entity configuration corresponding to the index, while all other protocol entity configurations remain unchanged. Updating protocol entity configurations selectively in this way enables efficient and precise adjustments to the radio bearer establishment procedure.

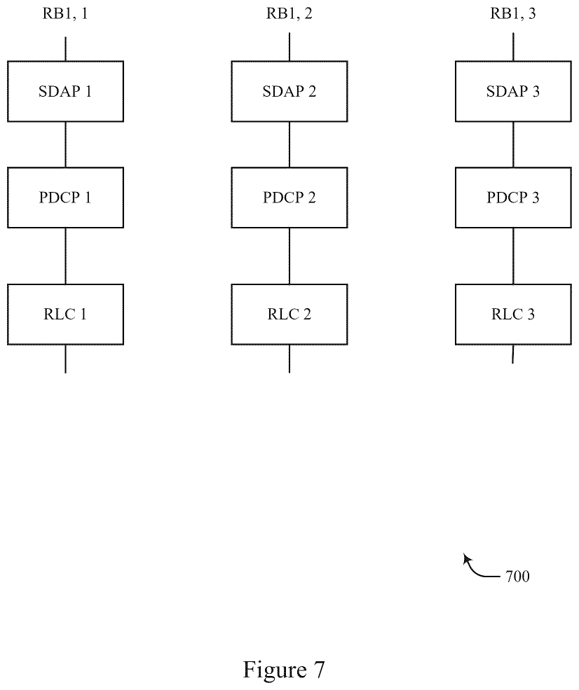

FIG. 7 illustrates an example of a radio bearer configuration 700 in accordance with aspects of the present disclosure. The radio bearer configuration 700 illustrates three, non-limiting variations of radio bearer configurations for a dynamic radio bearer (e.g., a dynamic DRB).

As described with reference to FIG. 6, a radio bearer (e.g., a dynamic radio bearer) may be established between a UE and an NE, which may allow for switching between different radio bearer configurations without performing a complete RRC reconfiguration procedure. In some implementations, the radio bearer may include a set of L2 or L3 protocol entity configurations. For example, the radio bearer may include an RRC configuration, an SDAP configuration, a PDCP configuration, an RLC configuration, or any combination thereof. In some examples, a radio bearer configuration may indicate parameters for different protocol entities (e.g., PDCP, SDAP, or RLC entities) for the radio bearer.

In some implementations, the radio bearer may be a GBR bearer or a non-GBR bearer. GBR bearers may provide a GBR and a maximum bit rate (MBR) for specific services, such as voice and video. Non-GBR bearers may share an aggregate maximum bit rate (AMBR) and are often used for best-effort traffic, such as Internet access and file downloads. A dynamic radio bearer, such as a dynamic DRB, may enable dynamic and efficient radio bearer updates.

The NE may configure a set of distinct radio bearer configurations, each including one or more protocol entity configurations as described herein. In addition, the NE may instruct the UE to establish one radio bearer configuration from the set of radio bearer configurations predefined by the NE. Each radio bearer configuration and each protocol entity configuration in a radio bearer configuration may be uniquely identified by an identifier, such as an index. In the example of FIG. 7, each of the three exemplary protocol entity configurations for each of the SDAP, PDCP, and RLC entities may be mapped to a corresponding index, enabling efficient identification and selection by the UE.

By way of example, a radio bearer (RB1) may support three radio bearer configurations. A first radio bearer configuration with an index RB1,1 may have an SDAP configuration 1, SDAP 1 (e.g., first of three SDAP entity configurations with an index 1), a PDCP configuration 1, PDCP 1 (e.g., first of three PDCP entity configurations with an index 1), and an RLC configuration 1, RLC 1 (e.g., first of three RLC entity configurations with an index 1). A second radio bearer configuration with an index RB1,2 and have an SDAP configuration 2, SDAP 2 (e.g., second of three SDAP configurations with an index 2), a PDCP configuration 2, PDCP 2 (e.g., second of three PDCP configurations with an index 2), and an RLC configuration 2, RLC 2 (e.g., second of three RLC configurations with an index 2). A third radio bearer configuration with an index RB1,3 may have an SDAP configuration 3, SDAP 3 (e.g., third of three SDAP configurations with an index 3), a PDCP configuration 3, PDCP 3 (e.g., third of three PDCP configurations with an index 3), and an RLC configuration 3, RLC 3 (e.g., third of three RLC configurations with an index 3). In this way, each individual protocol entity configuration may be mapped to a corresponding index. In addition, the three variations of radio bearer configurations may be flexibly applied to the same radio bearer (e.g., RB1) to meet specific performance and service requirements.

The NE may configure the UE to establish a radio bearer by explicitly signaling the index corresponding to the selected radio bearer configuration. During reconfiguration of an existing radio bearer, the NE may transmit both a radio bearer identity (e.g., RB1) and the index of the radio bearer configuration (e.g., RB1,1) to be applied to the specified radio bearer. In some examples, the NE may transmit a reconfiguration message via a MAC-CE that includes fields for the radio bearer identifier and the associated radio bearer configuration index. Alternatively, the NE may transmit the reconfiguration message via physical layer signaling such as DCI, which enables dynamic and efficient radio bearer updates.

In some implementations, for a given radio bearer, the NE may preconfigure a set of protocol entity configurations or specific parameters associated with at least one of a specific L2 functionality or a UE feature. Such functionalities may include SDAP functionalities (e.g., QoS aspects such as mapping QoS flows to DRBs), PDCP functionalities (e.g., handover procedures), RLC functionalities (e.g., ensuring reliable and efficient data transfer over a radio link), and MAC-CE functionalities (e.g., managing access to shared radio channels). The NE may direct the UE to apply one of these protocol entity configurations or parameters to the radio bearer. To facilitate dynamic updates of protocol entity configurations or parameters (such as those related to a specific functionality residing in an SDAP, PDCP, or RLC entity) without triggering a signaling-intensive RRC reconfiguration procedure, the NE may transmit an indication specifying which preconfigured protocol entity configuration or parameters to be applied to the radio bearer for a corresponding functionality. Each protocol entity configuration or parameter set within a predefined set of parameter sets for an L2 functionality may be uniquely identified by an identifier (e.g., index), enabling efficient signaling and minimal overhead during runtime reconfiguration.

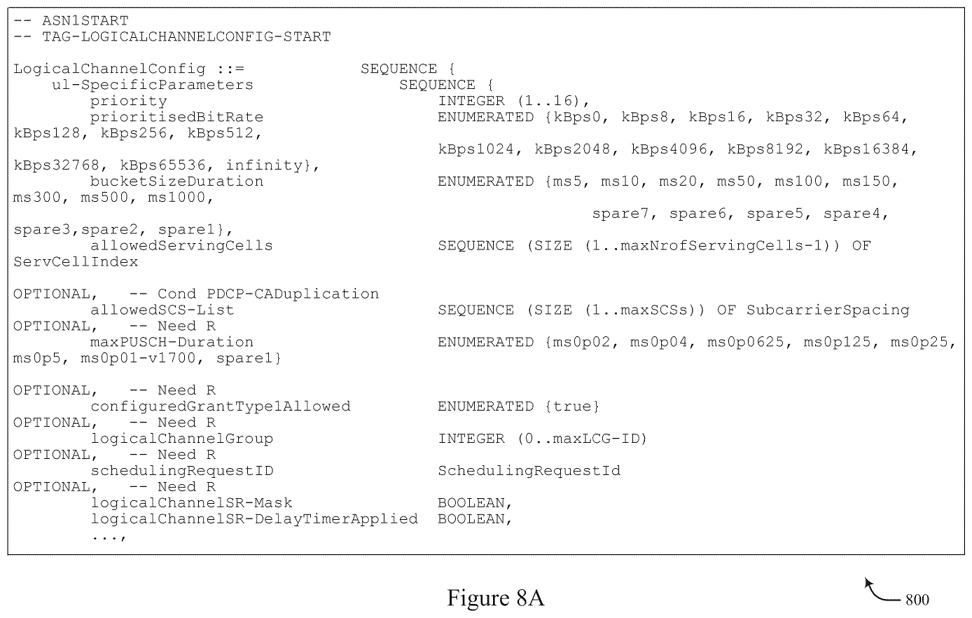

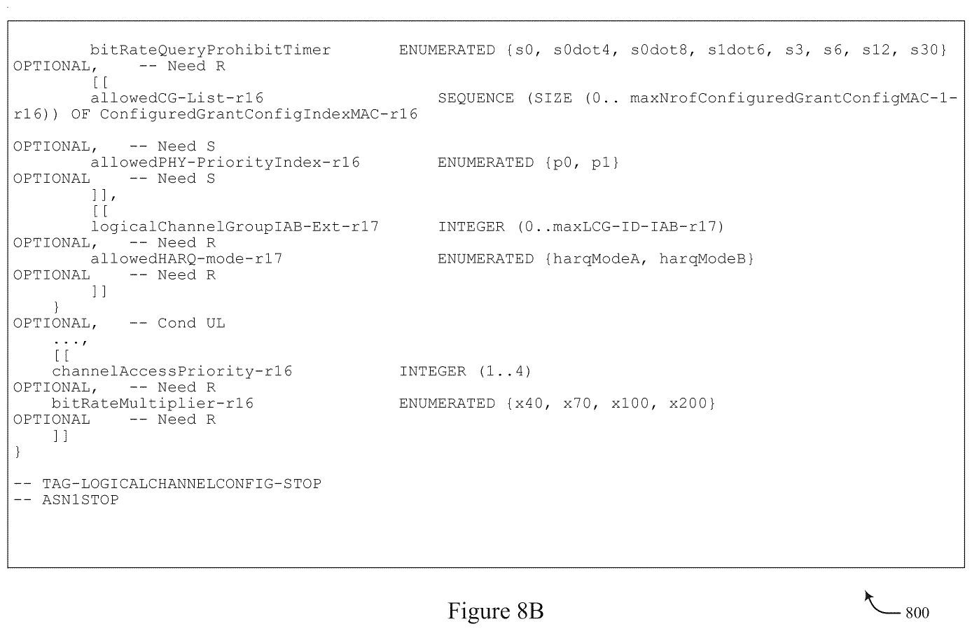

By way of example, the NE may preconfigure a set of multiple, distinct LCP-related parameter sets. Each LCP-related parameter set may include parameters such as prioritisedBitRate, bucketSizeDuration, and (LCH) priority, among others. Each LCP-related parameter set may be associated with an identifier (e.g., index). To change or modify specific LCP-related values or parameters for a particular radio bearer of the UE, the NE may indicate the identifier or index of the corresponding LCP-related parameter set to the UE. This enables efficient and low-overhead reconfiguration of LCP-related parameters without a full RRC reconfiguration procedure. An example of a LogicalChannelConfig 1E used to configure LCH parameters is illustrated in FIGS. 8A and 8B.

By way of another example, the NE may preconfigure a set of multiple, distinct LCH restriction parameter sets. Each LCH restriction parameter set may include parameters such as allowedSCS-List, maxPUSCH-Duration, configuredGrantType1Allowed, allowedServingCells, allowedCG-List, allowedPHY-PriorityIndex, and allowedHARQ-mode, among others. Each LCH restriction parameter set may be associated with an identifier (e.g., index). To change or modify specific LCH restriction values or parameters for a particular radio bearer of the UE, the NE may indicate the identifier or index of the corresponding LCH restriction parameter set to the UE.

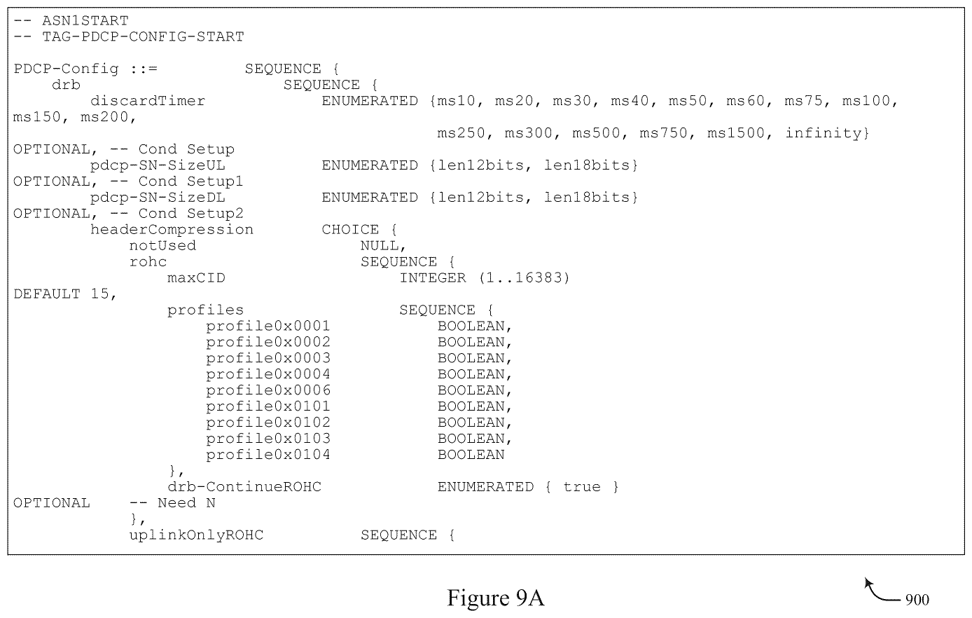

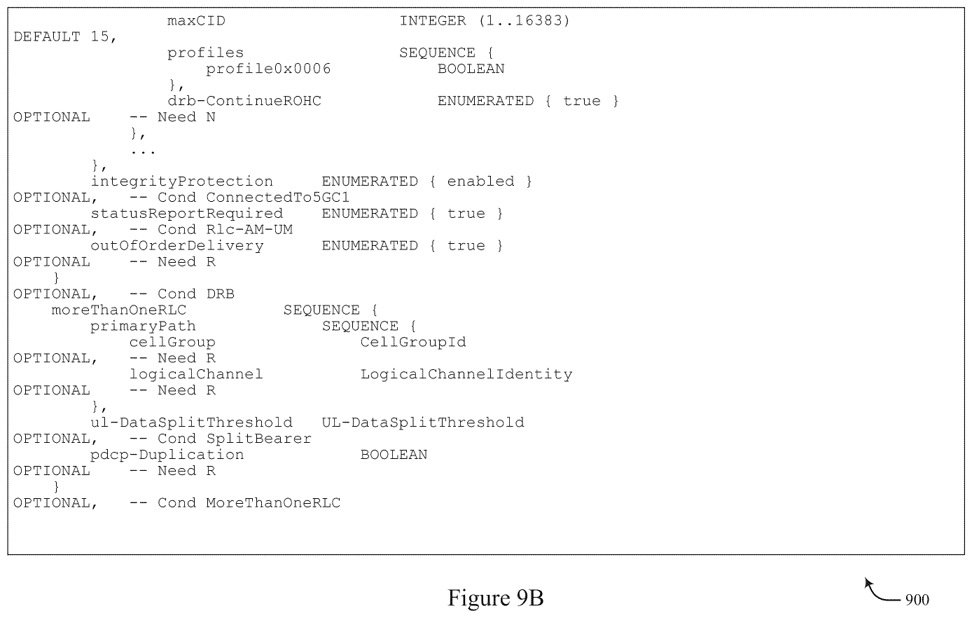

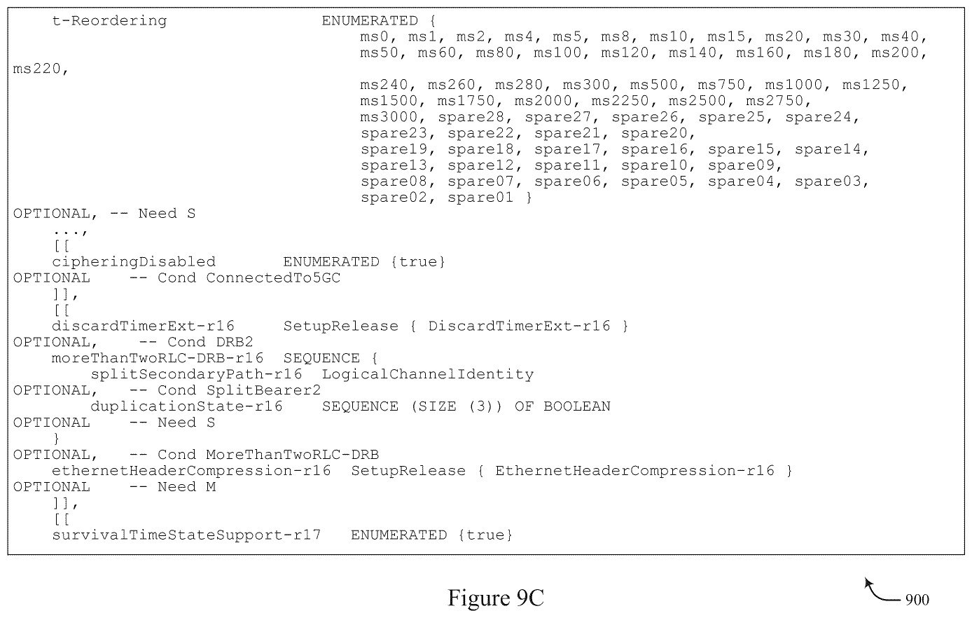

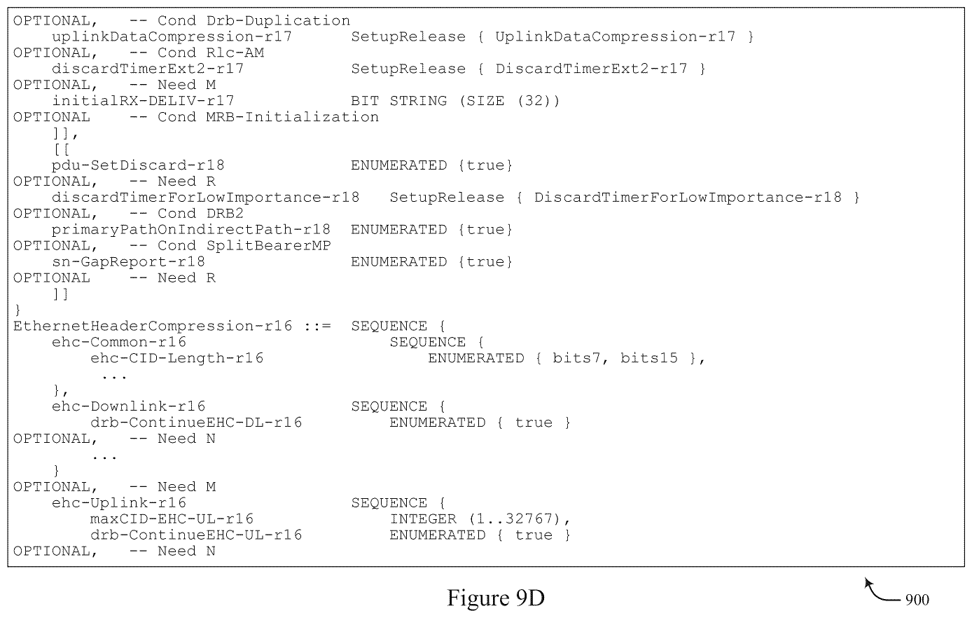

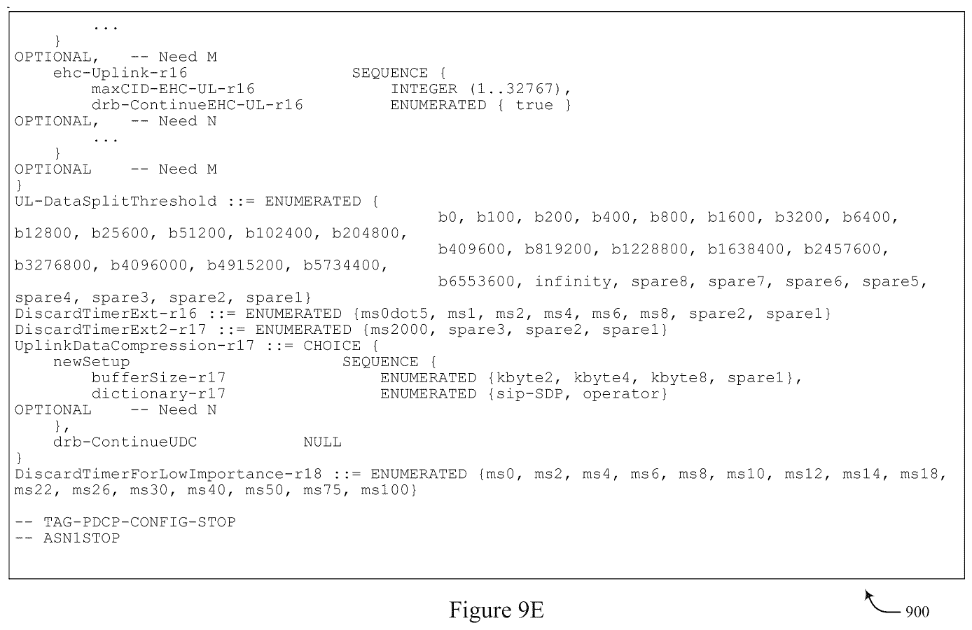

In some implementations, the NE may dynamically reconfigure protocol entity configurations or parameter sets at the radio bearer level to adapt QoS-related parameters. QoS-related parameters may include discardTimer, discardTimerForLowImportance, pdu-SetDiscard, remainingTimeThreshold, and t-Reordering, among others. Such parameters may influence PDCP behavior and play an important role in shaping bearer-level QoS performance. By preconfiguring multiple distinct configurations of QoS-related parameters, the NE may seamlessly switch between the configuration in response to changing service requirements, application profiles, and radio and network conditions. This capability also allows for agile, context-aware optimization of latency, reliability, and buffer management without incurring signaling overhead or latency penalties associated with full radio bearer reestablishment. Such dynamic L2 reconfiguration enhances the flexibility and efficiency of QoS handling, particularly in scenarios involving diverse and evolving traffic characteristics, such as immersive XR applications. An example of a PDCP-Config 1E used to configure PDCP and QoS-related parameters is illustrated in FIGS. 9A through 9E.

In some examples, the NE may preconfigure a set of distinct MAC configurations including parameter sets that are specific to the UE or a MAC entity rather than to individual radio bearers. The NE may select one or more of the MAC configurations based on current conditions or network requirements. In some implementations, the NE may switch between the MAC configurations or parameter sets using signaling at the MAC entity of the PHY layer. For example, for radio access technologies beyond 5G (e.g., 6G), the NE may preconfigure multiple sets of MAC-related parameters, such as those governing buffer status reporting (BSR), power headroom reporting (PHR), and LCP, including PBR values, LCH priorities, and token bucket related configurations. Similarly, discontinuous reception (DRX) related parameters or configurations may also be included. Such preconfigured parameter sets may enable the NE to rapidly adapt the UE's MAC entity behavior in response to changing traffic patterns, QoS demands, or network load without incurring the signaling overhead of reconfiguring individual parameters (e.g., using an RRC reconfiguration procedure). The use of L1 signaling (e.g., MAC-CE) or L2 signaling (e.g., DCI) may allow for low latency reconfiguration, improving responsiveness and overall system efficiency.

In one or more implementations, systems may utilize L1/L2-based switching and reconfiguration of DRX configurations to enable more efficient UE power saving. Such an approach may also be extended to other L2 procedures such as BSR, delay status reporting (DSR), and PHR. Specifically, L1/L2-based DRX reconfiguration may refer to an NE's ability to dynamically adapt already activated DRX configurations, or to activate or deactivate additional DRX configurations. This may allow for real-time adaptation of DRX behavior, accommodating diverse and evolving traffic patterns. Such dynamic reconfiguration may be useful in scenarios where a single DRX configuration is insufficient to meet the heterogeneous QoS demands of various traffic flows.

In some systems, one DRX configuration per serving cell may be configured at a given time. This limitation may restrict the NE's ability to adapt to the unique characteristics of multiple concurrent traffic flows, particularly for immersive applications (e.g., XR applications). As a result, a single, static DRX configuration may fail to appropriately balance power saving and latency, especially for immersive services such as XR. The single DRX configuration may be unable to closely follow potential short sleep opportunities and result in either low power saving gains or an increased traffic delay. Such DRX procedures may also be inefficient from a power-saving perspective as traffic characteristics of different QoS flows and radio bearers may be too different such that they are unable to be covered or tracked by a single DRX configuration.

For immersive services (e.g., XR multi-modality applications which include multiple related flows), it may be difficult to determine a single, static DRX configuration that covers all of the relevant flows. For example, AR applications may support two data flows in the downlink, video and audio/data, and three data flows in the uplink, video, pose/control, and audio/data. Each data flow may have a different periodicity, so it may be difficult to determine a periodicity and DRX on duration (e.g., Onduration) that satisfies requirements of all of the data flows to thereby enable a power saving gain.

According to the described techniques, the NE may transmit L2 signaling (e.g., a MAC-CE) or L1 signaling (e.g., DCI) to indicate whether to add or activate a new DRX configuration or to adapt an already existing and activated DRX configuration to support an XR or other immersive application. To adapt an existing DRX configuration, the NE may use RRC signaling to configure multiple distinct DRX parameter sets. Each DRX parameter set may be uniquely identified by an identifier, such as an index. To update a single DRX configuration, the NE may transmit an L1/L2 message that specifies an index that corresponds to a targeted DRX parameter set. Based on receiving the DRX parameter set, the UE (or a MAC entity) may terminate any currently running DRX-related timers and restart such timers based on the received DRX parameter set. Alternatively, based on receiving the DRX parameter set, the UE (or the MAC entity) may maintain the state of the currently running DRX-related timers and apply the new DRX configuration only when a relevant timer is started or restarted following the reconfiguration. Whether the UE terminates or maintains the timers and proceeds accordingly may be implementation-dependent and represent a trade-off between responsiveness and stability in DRX behavior.

To update multiple DRX configurations, the NE may transmit an L1/L2 message that indicates a DRX configuration index with a DRX parameter set index. To activate an additional DRX configuration, the L1/L2 message may indicate an additional, new DRX configuration index with a DRX parameter set index. To adapt one or more DRX parameters of an existing DRX configuration, the L1/L2 message may indicate the index of the activated DRX configuration for which the DRX parameters should be adapted, and an index of the DRX parameter set that is to be applied to the DRX configuration.

In some examples, the NE may reconfigure protocol entity configurations or parameter sets associated with one or more radio bearers, as described herein. The NE may execute the reconfiguration using signaling mechanisms such as MAC-CEs or PHY layer signaling without relocating a PDCP termination point. Additionally, the NE may perform the reconfiguration of particular L2 functionalities (e.g., PDCP, RLC, or MAC entity functionalities) without initiating a PDCP reestablishment procedure, an RLC reestablishment procedure, or a MAC reset procedure. Such reestablishment procedures may involve resetting protocol state variables and flushing transmission or reception buffers, which may result in data loss, increased latency, or service interruption. For example, a MAC reset procedure may affect all radio bearers associated with a same MAC entity due to operations such as hybrid automatic repeat request (HARQ) buffer flushing and timer reinitialization. Avoiding a MAC reset during bearer-specific configuration and reconfiguration, as described herein, may prevent undesired disruption to other bearers utilizing the same MAC entity. Similarly, avoiding PDCP or RLC reestablishment procedures may allow for a seamless operation that preserves data transmission and enhances service continuity.

In some implementations, during reconfiguration of L2 protocol entity configurations or parameters (including functionalities), the applicable protocol entities may remain active and continue normal operation. Specifically, state variables associated with PDCP and RLC transmission and reception functions, such as sequence number counters and protocol window state variables, may not be reset. Timers such as t-Reordering and discardTimer may continue running. Additionally, data stored within respective protocol buffers may be maintained, and no discard or reset operations are performed as part of the reconfiguration.

Following a reconfiguration of L2 protocol entity configurations or parameters, the UE may continue to apply the previous protocol entity configurations and parameters to data units (e.g., SDUs, PDUs), that are already present in the protocol entity. This includes SDUs that have been assigned sequence numbers (SNs) or PDUs that have already been generated. Conversely, new protocol entity configurations and parameters may be applied exclusively to newly incoming SDUs. For instance, the UE may continue to use previous RLC parameters (e.g., maxRetxThreshold, pollPDU, pollByte, and so forth) for SDUs and PDUs that were already in the RLC entity prior to the reconfiguration. Any updated RLC parameters are only applied to subsequent SDUs received after the reconfiguration event.

Additionally, the NE may selectively update timer behaviors. For instance, newly configured timers, such as t-Reordering, may be initiated only in response to triggering events occurring after the reconfiguration, for example, based on receipt of a segment of an SDU when additional segments of the same SDU are still pending. Timers already running at the time of the reconfiguration may continue uninterrupted and may not be reset or modified as part of the parameter update. Additionally, an LCH identifier corresponding to the reconfigured radio bearer may remain unchanged during reconfiguration. This ensures consistency in LCH-to-radio bearer mappings and obviates the need for additional signaling or remapping procedures.

In some implementations, control signaling, such as DCI or MAC-CE signaling, may explicitly indicate whether one or more of a PDCP recovery procedure, a PDCP reestablishment procedure, an RLC reestablishment procedure, or a MAC reset is to be performed. In the absence of such an indication, the reconfiguration may be non-disruptive, where the L2 protocol entities may apply updated parameters without protocol reinitialization. Such a signaling-based approach may provide flexibility in managing bearer-level reconfiguration while minimizing the impact of the reconfiguration on ongoing data transmissions and reducing the risk of data loss. As such, the NE may perform efficient, per-bearer reconfiguration of L2 protocol entity configurations and parameters in a manner that maintains protocol state, preserves data transmissions, and avoids unintended disruption of other radio bearers or services.

In some implementations, the UE may transmit assistance information (e.g., UE assistance information (UAI)) to the NE indicating a preferred radio bearer configuration. In one or more implementations, the NE may preconfigure a set of distinct protocol entity configurations for the UE, where each protocol entity configuration includes a set of parameters associated with one or more protocol entities or layers, such as SDAP, PDCP, or RLC. Each protocol entity configuration may be identified by a unique configuration identifier, such as an index. In some examples, the UE may transmit a message that includes one or more configuration indices, each configuration index corresponding to a preferred protocol entity configuration. For instance, the UE may independently indicate the index of a preferred PDCP configuration and the index of a preferred RLC configuration. This may allow fine-grained selection of protocol behavior tailored to traffic or a service type.

Alternatively, the NE may configure the UE with multiple radio bearer configuration sets, where each set may include a predefined combination of SDAP, PDCP, and in some cases, RLC parameter sets. Each radio bearer configuration set may also be assigned a unique configuration index. The UE may indicate its preferred radio bearer configuration by transmitting assistance information including the corresponding index to the NE. In some examples, the UE may transmit the indication of the preferred radio bearer configuration using a MAC-CE, which may include a single index or a set of indices corresponding to one or more preferred radio bearer configurations. This may enable low-latency and resource-efficient signaling, supporting rapid adaptation to dynamic QoS requirements or application behavior without requiring a full RRC reconfiguration procedure.

In some implementations, the UE may autonomously switch between multiple preconfigured L2 protocol entity configurations without requiring explicit signaling from the NE. This capability may allow the UE to dynamically adapt its protocol behavior to varying service conditions or traffic patterns with minimal latency and signaling overhead.

In some implementations, the UE may deactivate an active protocol entity configuration and activate an alternative protocol entity configuration from a predefined set configured by the NE (e.g., during RRC configuration or setup) based on a criterion. That is, the trigger for deactivating and activating (e.g., switching or changing between) protocol entity configurations may be based on predefined criteria, allowing the UE to make context-aware decisions locally. For instance, the switching capability may rely on L2-specific parameter. By way of example, the UE may dynamically select a PBR value from a set of configured PBR values for a given LCH. The selection may depend on local conditions such as buffer occupancy, QoS flow characteristics, or application-level triggers. Such autonomous switching may enhance protocol flexibility and responsiveness, enabling the UE to optimize its behavior in real time. In particular, the switching may be beneficial in scenarios involving highly variable or latency-sensitive traffic, such as XR, ultra-reliable low-latency communications (URLLC), or multi-flow applications, where static configurations may fall short in meeting dynamic performance demands.

In some implementations, the UE may be required to inform the NE whenever the UE autonomously switches an active protocol entity configuration or a set of L2 parameters. In this way, the NE may remain synchronized with the UE's active protocol entity configuration, enabling consistent and coordinated behavior. For example, based on activating a new protocol entity configuration, the UE may transmit an indication of an identifier or an index corresponding to the newly applied protocol entity configuration or a specific parameter set, where the new protocol entity configuration may have been predefined and provisioned by the NE. In some examples, the UE may transmit the indication via a MAC-CE. Alternatively, the UE may transmit the indication via in-band signaling, for example, an L2 protocol header that includes information of the newly applied protocol entity configuration.

The UE may explicitly notify the NE of such changes to a protocol entity configuration to maintain consistency with the NE. For example, the UE may indicate that the UE updated its LCP parameters, such as PBR or LCH priority, based on indicating a corresponding index. This may coordinate the UE and NE, particularly in scenarios involving dynamic bearer adaptations or autonomous UE behavior, which enhances overall system efficiency and reliability.

In some examples, different protocol entity configurations or parameter sets may be categorized into three distinct types, each defined by a level of control exercised by the NE over that protocol entity configuration and the reporting obligations of the UE. For example, a protocol entity configuration may be a network-controlled configuration, a UE-selectable configuration with mandatory reporting, or a UE-selectable configuration without reporting. Network-controlled configurations may include protocol entity configurations or parameter sets that are exclusively managed by the NE. The UE may not be permitted to modify or select from these configurations autonomously, and any changes to the configurations are initiated and applied by the NE.

UE-selectable configurations with mandatory reporting include a predefined set of protocol entity configurations or parameter sets which the UE is permitted to autonomously switch between. The set of protocol entity configurations may be preconfigured and authorized by the NE. Each time the UE switches protocol entity configurations, the UE is required to explicitly notify the NE of the new active protocol entity configuration to ensure that the NE maintains visibility into the UE's operational state while allowing for some degree of UE autonomy.

Alternatively, UE selectable configurations without reporting include a predefined set of protocol entity configurations or parameter sets which the UE is permitted to independently select and switch between without any obligation to inform the NE. Such configurations may enable fast, localized decision-making by the UE as NE-awareness of the specific protocol entity configuration the UE is using is not deemed as critical. For cases when a model for an AI/ML feature resides in the UE or generally for AI/ML-based features, the UE may be allowed to autonomously select a suitable protocol entity configuration or set of parameters. That is, the UE may autonomously switch between different AI/ML models and corresponding protocol entity configurations.

In some implementations, the NE may assign a configuration category or type (e.g., a network-controlled configuration, a UE-selectable configuration with mandatory reporting, or a UE-selectable configuration without reporting) to each protocol entity configuration or parameter set. Specifically, when provisioning a predefined set of protocol entity configuration or parameter sets for the UE, the NE may designate, for each protocol entity configuration or parameter set, an associated control category. This assignment may determine whether a given protocol entity configuration is to be exclusively controlled by the NE, subject to UE-initiated change with mandatory reporting, or eligible for autonomous UE modification without network modification.

In some implementations, the NE may reconfigure protocol entity configurations of a radio bearer (e.g., a DRB) when adapting the QoS requirements or parameters of a corresponding QoS flow to which the radio bearer is mapped. In such cases, the NE may simultaneously handle QoS flow adaptation and the corresponding radio bearer reconfiguration. To do this, the described techniques may support a new class of guaranteed QoS flows (e.g., adaptive or dynamic QoS flows), whose QoS requirements may be flexibly adjusted in accordance with the traffic characteristics of the associated application. For instance, such adaptive flows may be defined by a range of QoS parameters (e.g., a range of guaranteed flow bit rate (GFBR) or maximum data burst volume (MDBV) values. Additionally, the RAN may dynamically determine an applicable QoS level based on the characteristics of incoming downlink traffic. To make the determination, the RAN may use in-band information embedded in headers of downlink packets. Such in-band information may specify traffic characteristics or specific QoS requirements, such as acceptable packet error rate, on a per-packet basis. When QoS requirements of a QoS flow are adjusted, the associated radio bearer may be reconfigured accordingly, as described herein.

In some implementations, a DRB may be configured with a set of radio bearer configurations including various parameters (e.g., timers, MAC parameters, and so forth). Such configurations may be organized into different categories. For example, the configurations may be categorized based on which parameters may be switched without any RRC reconfiguration or reestablishment (e.g., mode switching), with an RRC reconfiguration or reestablishment, or with a partial reconfiguration or reestablishment. For example, a MAC reset may be required when particular parameters are switched, or timers may be reset or continued with new values. There may be no RRC configuration procedure when changing particular parameters. For example, an RLC transmit/receive window may continue running, where timers (e.g., PDCP discard timers) may be restarted. Without using an RRC reconfiguration procedure, MAC-CE and DCI signaling may be used to indicate the radio bearer configurations (e.g., by indication of an identifier or an index corresponding to a particular radio bearer configuration). Additionally, this may result in PDCP recovery and RLC reestablishment procedures happening on an as-required basis (e.g., instead of in every case).

In some examples, the NE may configure one or more default radio bearers, and the UE may switch between default radio bearers and inform the NE when a switch occurs. In such cases, a particular configuration may be activated or deactivated via MAC-CE or DCI signaling based on a criterion. For packets that are already being transmitted with an existing configuration, a COUNT value may continue and the UE may perform an intra-UE handover procedure. Additionally, there may be an indication of an RLC reset or reestablishment, though the RLC entity may remain unchanged, avoiding unnecessary re-transmissions. This may be based on a congestion level of the NE, a PDCP sequence number gap report, and a PDCP discard timer. In such cases, an LCH identifier may remain the same.

FIGS. 8A and 8B illustrate an example of an IE 800 in accordance with aspects of the present disclosure. The IE 800 is an example of a LogicalChannelConfig 1E used to configure (e.g., add or modify) LCH parameters. In some examples, the LCH parameters may be included in a parameter set configured for a radio bearer. The IE 800 may include parameters (e.g., fields) such as prioritisedBitRate, bucketSizeDuration, and (LCH) priority, among others. For example, the prioritisedBitRate parameter may indicate a minimum data rate that a logical channel may be granted over time, ensuring that particular services with dynamic traffic characteristics such as voice and video applications have sufficient radio resources. The bucketSizeDuration parameter may indicate a division of available bandwidth into buckets, where traffic may be assigned to each bucket based on traffic priorities.

The LCH parameters indicated in the IE 800 may be included in a parameter set configured by the NE, and the parameter set may be associated with an identifier (e.g., index). To change or modify specific LCH parameters for a particular radio bearer of the UE, the NE may indicate the identifier or index of the corresponding parameter set.

FIGS. 9A through 9E illustrate an example of an IE 900 in accordance with aspects of the present disclosure. The IE 900 is an example of a PDCP-Config 1E used to set (e.g., configure, add, or modify) configurable PDCP parameters for signaling, multicast-broadcast services (MBS) multicast, and DRBs, including dynamic DRBs. In some examples, the PDCP parameters may be included in a parameter set configured for a radio bearer. In this way, the PDCP parameters may be or may include QoS-related parameters as they may influence PDCP behavior and impact bearer-level QoS performance.

The IE 900 may include parameters (e.g., fields) such as discardTimer, discardTimerForLowImportance, pdu-SetDiscard, remainingTimeThreshold, and t-Reordering, among others. For example, the discardTimer parameter may be used to manage a duration after which unacknowledged packets are discarded in the PDCP entity. The discardTimerForLowImportance parameter may be used to manage the discard behavior of packets in the PDCP entity with relatively lower priorities or PDU set importance. The pdu-SetDiscard parameter may be used to manage the discard behavior of PDCP packets (e.g., service data units (SDUs)) belonging to a particular PDU set. The remainingTimeThreshold parameter may track the time until a packet should be discarded if the packet is unsuccessfully transmitted (e.g., during the discard timer). The t-Reordering parameter may be used to manage reliable in-sequence delivery of packets, particularly when packets have been discarded.

The PDCP parameters indicated in the IE 900 may be included in a parameter set configured by the NE, and the parameter set may be associated with an identifier (e.g., index). To change or modify specific PDCP parameters for a particular radio bearer of the UE, the NE may indicate the identifier or index of the corresponding parameter set.

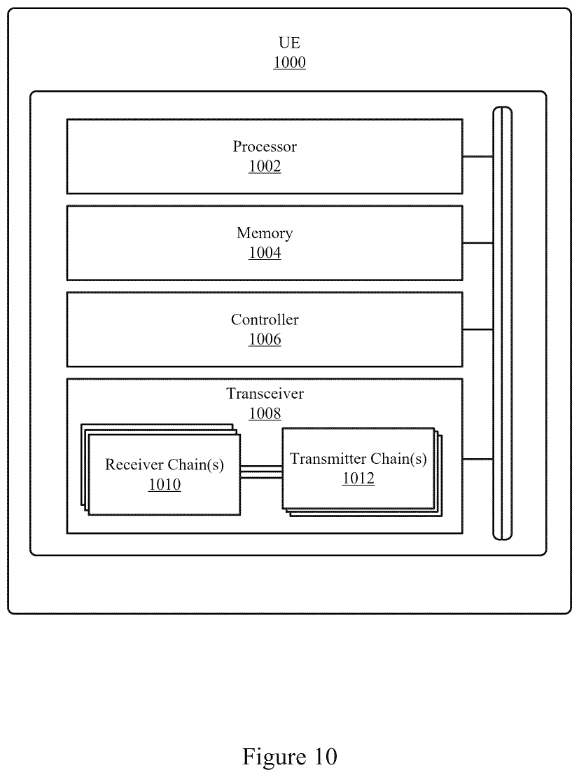

FIG. 10 illustrates an example of a UE 1000 in accordance with aspects of the present disclosure. The UE 1000 may include a processor 1002, a memory 1004, a controller 1006, and a transceiver 1008. The processor 1002, the memory 1004, the controller 1006, or the transceiver 1008, or various combinations thereof or various components thereof may be examples of means for performing various aspects of the present disclosure as described herein. These components may be coupled (e.g., operatively, communicatively, functionally, electronically, electrically) via one or more interfaces.

The processor 1002, the memory 1004, the controller 1006, or the transceiver 1008, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1002 may include an intelligent hardware device (e.g., a general-purpose processor, a DSP, a CPU, an ASIC, an FPGA, or any combination thereof). In some implementations, the processor 1002 may be configured to operate the memory 1004. In some other implementations, the memory 1004 may be integrated into the processor 1002. The processor 1002 may be configured to execute computer-readable instructions stored in the memory 1004 to cause the UE 1000 to perform various functions of the present disclosure.

The memory 1004 may include volatile or non-volatile memory. The memory 1004 may store computer-readable, computer-executable code including instructions when executed by the processor 1002 cause the UE 1000 to perform various functions described herein. The code may be stored in a non-transitory computer-readable medium such as the memory 1004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1002 and the memory 1004 coupled with the processor 1002 may be configured to cause the UE 1000 to perform one or more of the functions described herein (e.g., executing, by the processor 1002, instructions stored in the memory 1004). For example, the processor 1002 may support wireless communication at the UE 1000 in accordance with examples as disclosed herein. The UE 1000 may be configured to or operable to support a means for receiving first configuration information associated with a radio bearer, where the first configuration information includes a set of multiple configurations for a set of multiple protocol entities; receiving second configuration information associated with the radio bearer, where the second configuration information includes one or more identifiers, where each identifier of the one or more identifiers corresponds to a configuration of the set of multiple configurations; and configuring the radio bearer based on the second configuration information.

Additionally, the UE 1000 may be configured to support any one or combination of configuring a protocol entity associated with the radio bearer based on the configuration of the set of multiple configurations; where the set of multiple configurations includes at least one full configuration and at least one delta configuration, where a full configuration includes a set of parameters for a protocol entity of the set of multiple protocol entities and a delta configuration includes one or more parameters for the protocol entity that differ from a previous full configuration; deactivating a first configuration of the set of multiple configurations and activating a second configuration of the set of multiple configurations for the radio bearer based on a criterion; and transmitting an indication of the activated second configuration; where the first configuration information further includes a set of multiple radio bearer configurations, each radio bearer configuration including one or more configurations of the set of multiple configurations, and the second configuration information includes an identifier of the one or more identifiers corresponding to a radio bearer configuration of the set of multiple radio bearer configurations, and where the radio bearer is configured based on the radio bearer configuration; where the first configuration information further includes a set of multiple parameter sets for a functionality associated with the radio bearer, and where the radio bearer is configured based at least on part on a parameter set of the set of multiple parameter sets; where the first configuration information further includes a set of multiple LCP parameter sets, where each LCP parameter set of the set of multiple LCP parameter sets corresponds to an identifier of the one or more identifiers, and where the radio bearer, the UE, the processor, and the method may further be configured to, capable of, operable to, performed to, or performable to receive a signal indicating the identifier of an LCP parameter set; and apply the LCP parameter set to the radio bearer based on the signal; where the set of multiple configurations includes at least one MAC parameter configuration, and where the one or more processors are further operable to cause the UE to receive a message indicating a MAC parameter configuration based on one or more service requirements; transmitting assistance information indicating a preferred configuration of the set of multiple configurations; where each protocol entity of the set of multiple protocol entities corresponds to at least one configuration of the set of multiple configurations; where the set of multiple configurations includes at least one of an NE-controlled configuration, a UE-selectable configuration that is indicated to an NE, or a UE-selectable configuration that is not indicated to the NE; or where the second configuration information is received via a MAC-CE or DCI.

Additionally, or alternatively, the UE 1000 may support at least one memory (e.g., the memory 1004) and at least one processor (e.g., the processor 1002) coupled with the at least one memory and configured to cause the UE to receive first configuration information associated with a radio bearer, where the first configuration information includes a set of multiple configurations for a set of multiple protocol entities; receive second configuration information associated with the radio bearer, where the second configuration information includes one or more identifiers, where each identifier of the one or more identifiers corresponds to a configuration of the set of multiple configurations; and configure the radio bearer based on the second configuration information.

Additionally, the UE 1000 may be configured to support any one or combination of configuring a protocol entity associated with the radio bearer based on the configuration of the set of multiple configurations; where the set of multiple configurations includes at least one full configuration and at least one delta configuration, where a full configuration includes a set of parameters for a protocol entity of the set of multiple protocol entities and a delta configuration includes one or more parameters for the protocol entity that differ from a previous full configuration; deactivating a first configuration of the set of multiple configurations and activating a second configuration of the set of multiple configurations for the radio bearer based on a criterion; and transmitting an indication of the activated second configuration; where the first configuration information further includes a set of multiple radio bearer configurations, each radio bearer configuration including one or more configurations of the set of multiple configurations, and the second configuration information includes an identifier of the one or more identifiers corresponding to a radio bearer configuration of the set of multiple radio bearer configurations, and where the radio bearer is configured based on the radio bearer configuration; where the first configuration information further includes a set of multiple parameter sets for a functionality associated with the radio bearer, and where the radio bearer is configured based at least on part on a parameter set of the set of multiple parameter sets; where the first configuration information further includes a set of multiple LCP parameter sets, where each LCP parameter set of the set of multiple LCP parameter sets corresponds to an identifier of the one or more identifiers, and where the radio bearer, the UE, the processor, and the method may further be configured to, capable of, operable to, performed to, or performable to receive a signal indicating the identifier of an LCP parameter set; and apply the LCP parameter set to the radio bearer based on the signal; where the set of multiple configurations includes at least one MAC parameter configuration, and where the one or more processors are further operable to cause the UE to receive a message indicating a MAC parameter configuration based on one or more service requirements; transmitting assistance information indicating a preferred configuration of the set of multiple configurations; where each protocol entity of the set of multiple protocol entities corresponds to at least one configuration of the set of multiple configurations; where the set of multiple configurations includes at least one of an NE-controlled configuration, a UE-selectable configuration that is indicated to an NE, or a UE-selectable configuration that is not indicated to the NE; or where the second configuration information is received via a MAC-CE or DCI.

The controller 1006 may manage input and output signals for the UE 1000. The controller 1006 may also manage peripherals not integrated into the UE 1000. In some implementations, the controller 1006 may utilize an operating system such as iOS®, ANDROID®, WINDOWS®, or other operating systems. In some implementations, the controller 1006 may be implemented as part of the processor 1002.

In some implementations, the UE 1000 may include at least one transceiver 1008. In some other implementations, the UE 1000 may have more than one transceiver 1008. The transceiver 1008 may represent a wireless transceiver. The transceiver 1008 may include one or more receiver chains 1010, one or more transmitter chains 1012, or a combination thereof.

A receiver chain 1010 may be configured to receive signals (e.g., control information, data, packets) over a wireless medium. For example, the receiver chain 1010 may include one or more antennas to receive a signal over the air or wireless medium. The receiver chain 1010 may include at least one amplifier (e.g., a low-noise amplifier (LNA)) configured to amplify the received signal. The receiver chain 1010 may include at least one demodulator configured to demodulate the received signal and obtain the transmitted data by reversing the modulation technique applied during transmission of the signal. The receiver chain 1010 may include at least one decoder for decoding the demodulated signal to receive the transmitted data.

A transmitter chain 1012 may be configured to generate and transmit signals (e.g., control information, data, packets). The transmitter chain 1012 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1012 may also include at least one power amplifier configured to amplify the modulated signal to an appropriate power level suitable for transmission over the wireless medium. The transmitter chain 1012 may also include one or more antennas for transmitting the amplified signal into the air or wireless medium.

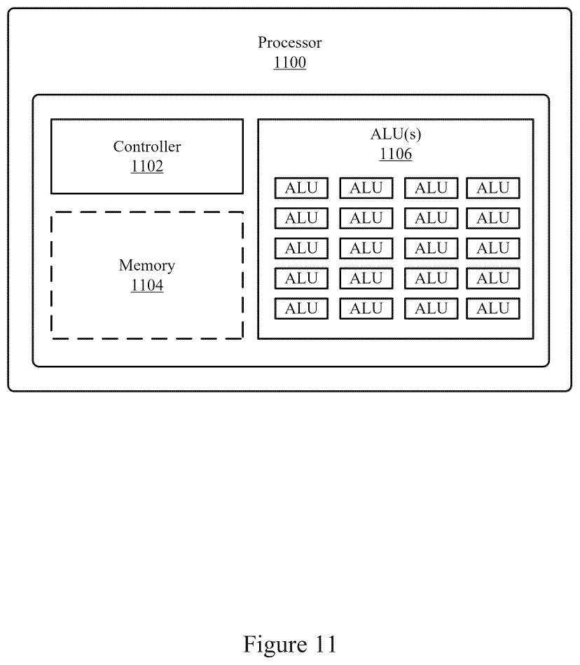

FIG. 11 illustrates an example of a processor 1100 in accordance with aspects of the present disclosure. The processor 1100 may be an example of a processor configured to perform various operations in accordance with examples as described herein. The processor 1100 may include a controller 1102 configured to perform various operations in accordance with examples as described herein. The processor 1100 may optionally include at least one memory 1104, which may be, for example, an L1/L2/L3 cache. Additionally, or alternatively, the processor 1100 may optionally include one or more arithmetic-logic units (ALUs) 1106. One or more of these components may be in electronic communication or otherwise coupled (e.g., operatively, communicatively, functionally, electronically, electrically) via one or more interfaces (e.g., buses).

The processor 1100 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1100) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1102 may be configured to manage and coordinate various operations (e.g., signaling, receiving, obtaining, retrieving, transmitting, outputting, forwarding, storing, determining, identifying, accessing, writing, reading) of the processor 1100 to cause the processor 1100 to support various operations in accordance with examples as described herein. For example, the controller 1102 may operate as a control unit of the processor 1100, generating control signals that manage the operation of various components of the processor 1100. These control signals include enabling or disabling functional units, selecting data paths, initiating memory access, and coordinating timing of operations.

The controller 1102 may be configured to fetch (e.g., obtain, retrieve, receive) instructions from the memory 1104 and determine subsequent instruction(s) to be executed to cause the processor 1100 to support various operations in accordance with examples as described herein. The controller 1102 may be configured to track memory addresses of instructions associated with the memory 1104. The controller 1102 may be configured to decode instructions to determine the operation to be performed and the operands involved. For example, the controller 1102 may be configured to interpret the instruction and determine control signals to be output to other components of the processor 1100 to cause the processor 1100 to support various operations in accordance with examples as described herein. Additionally, or alternatively, the controller 1102 may be configured to manage flow of data within the processor 1100. The controller 1102 may be configured to control transfer of data between registers, ALUs 1106, and other functional units of the processor 1100.

The memory 1104 may include one or more caches (e.g., memory local to or included in the processor 1100 or other memory, such as RAM, ROM, DRAM, SDRAM, SRAM, MRAM, flash memory, etc. In some implementations, the memory 1104 may reside within or on a processor chipset (e.g., local to the processor 1100). In some other implementations, the memory 1104 may reside external to the processor chipset (e.g., remote to the processor 1100).

The memory 1104 may store computer-readable, computer-executable code including instructions that, when executed by the processor 1100, cause the processor 1100 to perform various functions described herein. The code may be stored in a non-transitory computer-readable medium such as system memory or another type of memory. The controller 1102 and/or the processor 1100 may be configured to execute computer-readable instructions stored in the memory 1104 to cause the processor 1100 to perform various functions. For example, the processor 1100 and/or the controller 1102 may be coupled with or to the memory 1104, the processor 1100, and the controller 1102, and may be configured to perform various functions described herein. In some examples, the processor 1100 may include multiple processors and the memory 1104 may include multiple memories. One or more of the multiple processors may be coupled with one or more of the multiple memories, which may, individually or collectively, be configured to perform various functions herein.

The one or more ALUs 1106 may be configured to support various operations in accordance with examples as described herein. In some implementations, the one or more ALUs 1106 may reside within or on a processor chipset (e.g., the processor 1100). In some other implementations, the one or more ALUs 1106 may reside external to the processor chipset (e.g., the processor 1100). One or more ALUs 1106 may perform one or more computations such as addition, subtraction, multiplication, and division on data. For example, one or more ALUs 1106 may receive input operands and an operation code, which determines an operation to be executed. One or more ALUs 1106 may be configured with a variety of logical and arithmetic circuits, including adders, subtractors, shifters, and logic gates, to process and manipulate the data according to the operation. Additionally, or alternatively, the one or more ALUs 1106 may support logical operations such as AND, OR, exclusive-OR (XOR), not-OR (NOR), and not-AND (NAND), enabling the one or more ALUs 1106 to handle conditional operations, comparisons, and bitwise operations.

The processor 1100 may support wireless communication in accordance with examples as disclosed herein. The processor 1100 may be configured to or operable to support at least one controller (e.g., the controller 1102) coupled with at least one memory (e.g., the memory 1104) and configured to cause the processor to receive first configuration information associated with a radio bearer, where the first configuration information includes a set of multiple configurations for a set of multiple protocol entities; receive second configuration information associated with the radio bearer, where the second configuration information includes one or more identifiers, where each identifier of the one or more identifiers corresponds to a configuration of the set of multiple configurations; and configure the radio bearer based on the second configuration information.

Additionally, the processor 1100 may be configured to or operable to support any one or combination of configuring a protocol entity associated with the radio bearer based on the configuration of the set of multiple configurations; where the set of multiple configurations includes at least one first configuration and at least one second configuration, where a first configuration includes a set of parameters for a protocol entity of the set of multiple protocol entities and a second configuration includes a subset of the set of parameters for the protocol entity that differ from the first configuration; deactivating a first configuration of the set of multiple configurations and activating a second configuration of the set of multiple configurations for the radio bearer based on a criterion; and transmitting an indication of the activated second configuration; where the first configuration information further includes a set of multiple radio bearer configurations, each radio bearer configuration including one or more configurations of the set of multiple configurations, and the second configuration information includes an identifier of the one or more identifiers corresponding to a radio bearer configuration of the set of multiple radio bearer configurations, and where the radio bearer is configured based on the radio bearer configuration; where the first configuration information further includes a set of multiple parameter sets for a functionality associated with the radio bearer, and where the radio bearer is configured based at least on part on a parameter set of the set of multiple parameter sets; where the first configuration information further includes a set of multiple LCP parameter sets, where each LCP parameter set of the set of multiple LCP parameter sets corresponds to an identifier of the one or more identifiers, and where the radio bearer, the UE, the processor, and the method may further be configured to, capable of, operable to, performed to, or performable to receive a signal indicating the identifier of an LCP parameter set; and apply the LCP parameter set to the radio bearer based on the signal; where the set of multiple configurations includes at least one MAC parameter configuration, and where the one or more processors are further operable to cause the UE to receive a message indicating a MAC parameter configuration based on one or more service requirements; transmitting assistance information indicating a preferred configuration of the set of multiple configurations; where each protocol entity of the set of multiple protocol entities corresponds to at least one configuration of the set of multiple configurations; where the set of multiple configurations includes at least one of an NE-controlled configuration, a UE-selectable configuration that is indicated to an NE, or a UE-selectable configuration that is not indicated to the NE; or where the second configuration information is received via a MAC-CE or DCI.

The processor 1100 may support wireless communication in accordance with examples as disclosed herein. The processor 1100 may be configured to or operable to support at least one controller (e.g., the controller 1102) coupled with at least one memory (e.g., the memory 1104) and configured to cause the processor to transmit first configuration information associated with a radio bearer, where the first configuration information includes a set of multiple configurations for a set of multiple protocol entities; and transmit second configuration information associated with the radio bearer, where the second configuration information includes one or more identifiers, where each identifier of the one or more identifiers corresponds to a configuration of the set of multiple configurations, and where the radio bearer is configured based on the second configuration information.

Additionally, the processor 1100 may be configured to or operable to support any one or combination of where the protocol entity associated with the radio bearer is configured based on a configuration of the set of multiple configurations; where the set of multiple configurations includes at least one first configuration and at least one second configuration, and where a first configuration includes a subset of the set of parameters for a protocol entity of the set of multiple protocol entities and a second configuration includes one or more parameters for the protocol entity that differ from the first configuration; receiving an indication of an activated configuration of the set of multiple configurations; reconfiguring the configuration of the radio bearer based on one or more QoS parameters associated with a QoS flow that is mapped to the radio bearer; where the first configuration information further includes a set of multiple radio bearer configurations, each radio bearer configuration includes one or more configurations of the set of multiple configurations, and the second configuration information includes an identifier of the one or more identifiers corresponding to a radio bearer configuration of the set of multiple radio bearer configuration, and where the radio bearer is configured based on the radio bearer configuration; where the first configuration information further includes a set of multiple parameter sets for a functionality associated with the radio bearer, and where the radio bearer is configured based at least on part on a parameter set of the set of multiple parameter sets; where the first configuration information further includes a set of multiple LCP parameter sets, where each LCP parameter set of the set of multiple LCP parameter sets corresponds to an identifier of the one or more identifiers, and where the NE, the processor, and the method described herein, the NE, the processor, and the method may further be configured to, capable of, operable to, performed to, or performable to transmit a signal indicating the identifier of an LCP parameter set, where the LCP parameter set is applied to the radio bearer based on the signal; where the set of multiple configurations includes at least one MAC parameter configuration, where the NE, the processor, and the method described herein, the NE, the processor, and the method may further be configured to, capable of, operable to, performed to, or performable to select a MAC parameter configuration based on one or more service requirements; and transmit a message indicating the selected MAC parameter configuration; receiving assistance information indicating a preferred configuration of the set of multiple configurations; where each protocol entity of the set of multiple protocol entities corresponds to at least one configuration of the set of multiple configurations; where the set of multiple configurations include at least one of an NE-controlled configuration, a UE-selectable configuration that is indicated to the NE, or a UE-selectable configuration that is not indicated to the NE; or where the second configuration information is transmitted via a MAC-CE or DCI.

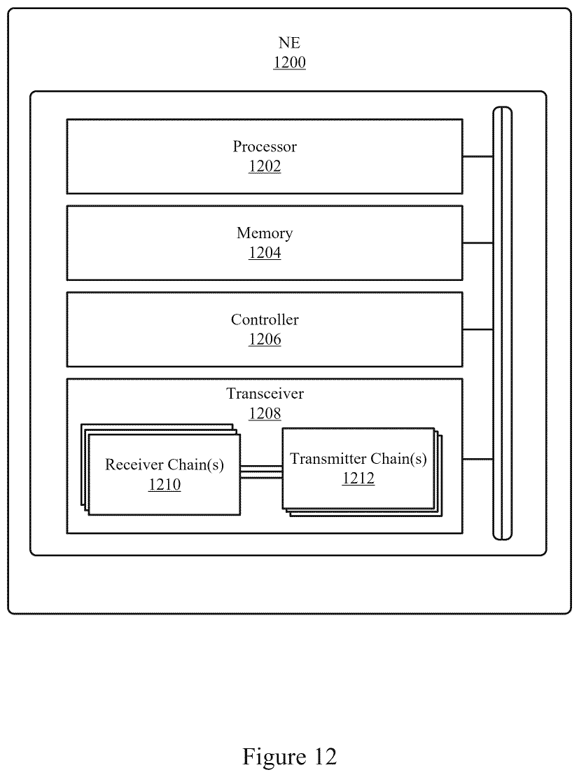

FIG. 12 illustrates an example of an NE 1200 in accordance with aspects of the present disclosure. The NE 1200 may include a processor 1202, a memory 1204, a controller 1206, and a transceiver 1208. The processor 1202, the memory 1204, the controller 1206, or the transceiver 1208, or various combinations thereof or various components thereof may be examples of means for performing various aspects of the present disclosure as described herein. These components may be coupled (e.g., operatively, communicatively, functionally, electronically, electrically) via one or more interfaces.

The processor 1202, the memory 1204, the controller 1206, or the transceiver 1208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1202 may include an intelligent hardware device (e.g., a general-purpose processor, a DSP, a CPU, an ASIC, an FPGA, or any combination thereof). In some implementations, the processor 1202 may be configured to operate the memory 1204. In some other implementations, the memory 1204 may be integrated into the processor 1202. The processor 1202 may be configured to execute computer-readable instructions stored in the memory 1204 to cause the NE 1200 to perform various functions of the present disclosure.

The memory 1204 may include volatile or non-volatile memory. The memory 1204 may store computer-readable, computer-executable code including instructions when executed by the processor 1202 cause the NE 1200 to perform various functions described herein. The code may be stored in a non-transitory computer-readable medium such as the memory 1204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1202 and the memory 1204 coupled with the processor 1202 may be configured to cause the NE 1200 to perform one or more of the functions described herein (e.g., executing, by the processor 1202, instructions stored in the memory 1204). For example, the processor 1202 may support wireless communication at the NE 1200 in accordance with examples as disclosed herein. The NE 1200 may be configured to or operable to support a means for transmitting first configuration information associated with a radio bearer, where the first configuration information includes a set of multiple configurations for a set of multiple protocol entities; and transmitting second configuration information associated with the radio bearer, where the second configuration information includes one or more identifiers, where each identifier of the one or more identifiers corresponds to a configuration of the set of multiple configurations, and where the radio bearer is configured based on the second configuration information.

Additionally, the NE 1200 may be configured to or operable to support any one or combination of where the protocol entity associated with the radio bearer is configured based on a configuration of the set of multiple configurations; where the set of multiple configurations includes at least one first configuration and at least one second configuration, and where a first configuration includes a subset of the set of parameters for a protocol entity of the set of multiple protocol entities and a second configuration includes one or more parameters for the protocol entity that differ from the first configuration; receiving an indication of an activated configuration of the set of multiple configurations; reconfiguring the configuration of the radio bearer based on one or more QoS parameters associated with a QoS flow that is mapped to the radio bearer; where the first configuration information further includes a set of multiple radio bearer configurations, each radio bearer configuration includes one or more configurations of the set of multiple configurations, and the second configuration information includes an identifier of the one or more identifiers corresponding to a radio bearer configuration of the set of multiple radio bearer configuration, and where the radio bearer is configured based on the radio bearer configuration; where the first configuration information further includes a set of multiple parameter sets for a functionality associated with the radio bearer, and where the radio bearer is configured based at least on part on a parameter set of the set of multiple parameter sets; where the first configuration information further includes a set of multiple LCP parameter sets, where each LCP parameter set of the set of multiple LCP parameter sets corresponds to an identifier of the one or more identifiers, and where the NE, the processor, and the method described herein, the NE, the processor, and the method may further be configured to, capable of, operable to, performed to, or performable to transmit a signal indicating the identifier of an LCP parameter set, where the LCP parameter set is applied to the radio bearer based on the signal; where the set of multiple configurations includes at least one MAC parameter configuration, where the NE, the processor, and the method described herein, the NE, the processor, and the method may further be configured to, capable of, operable to, performed to, or performable to select a MAC parameter configuration based on one or more service requirements; and transmit a message indicating the selected MAC parameter configuration; receiving assistance information indicating a preferred configuration of the set of multiple configurations; where each protocol entity of the set of multiple protocol entities corresponds to at least one configuration of the set of multiple configurations; where the set of multiple configurations include at least one of an NE-controlled configuration, a UE-selectable configuration that is indicated to the NE, or a UE-selectable configuration that is not indicated to the NE; or where the second configuration information is transmitted via a MAC-CE or DCI.

Additionally, or alternatively, the NE 1200 may support at least one memory (e.g., the memory 1204) and at least one processor (e.g., the processor 1202) coupled with the at least one memory and configured to cause the NE to transmit first configuration information associated with a radio bearer, where the first configuration information includes a set of multiple configurations for a set of multiple protocol entities; and transmit second configuration information associated with the radio bearer, where the second configuration information includes one or more identifiers, where each identifier of the one or more identifiers corresponds to a configuration of the set of multiple configurations, and where the radio bearer is configured based on the second configuration information.

Additionally, the NE 1200 may be configured to support any one or combination of where the protocol entity associated with the radio bearer is configured based on a configuration of the set of multiple configurations; where the set of multiple configurations includes at least one first configuration and at least one second configuration, and where a first configuration includes a set of parameters for a protocol entity of the set of multiple protocol entities and a second configuration includes a subset of the one or more parameters for the protocol entity that differ from the first configuration; receiving an indication of an activated configuration of the set of multiple configurations; reconfiguring the configuration of the radio bearer based on one or more QoS parameters associated with a QoS flow that is mapped to the radio bearer; where the first configuration information further includes a set of multiple radio bearer configurations, each radio bearer configuration includes one or more configurations of the set of multiple configurations, and the second configuration information includes an identifier of the one or more identifiers corresponding to a radio bearer configuration of the set of multiple radio bearer configuration, and where the radio bearer is configured based on the radio bearer configuration; where the first configuration information further includes a set of multiple parameter sets for a functionality associated with the radio bearer, and where the radio bearer is configured based at least on part on a parameter set of the set of multiple parameter sets; where the first configuration information further includes a set of multiple LCP parameter sets, where each LCP parameter set of the set of multiple LCP parameter sets corresponds to an identifier of the one or more identifiers, and where the NE, the processor, and the method described herein, the NE, the processor, and the method may further be configured to, capable of, operable to, performed to, or performable to transmit a signal indicating the identifier of an LCP parameter set, where the LCP parameter set is applied to the radio bearer based on the signal; where the set of multiple configurations includes at least one MAC parameter configuration, where the NE, the processor, and the method described herein, the NE, the processor, and the method may further be configured to, capable of, operable to, performed to, or performable to select a MAC parameter configuration based on one or more service requirements; and transmit a message indicating the selected MAC parameter configuration; receiving assistance information indicating a preferred configuration of the set of multiple configurations; where each protocol entity of the set of multiple protocol entities corresponds to at least one configuration of the set of multiple configurations; where the set of multiple configurations include at least one of an NE-controlled configuration, a UE-selectable configuration that is indicated to the NE, or a UE-selectable configuration that is not indicated to the NE; or where the second configuration information is transmitted via a MAC-CE or DCI.

The controller 1206 may manage input and output signals for the NE 1200. The controller 1206 may also manage peripherals not integrated into the NE 1200. In some implementations, the controller 1206 may utilize an operating system such as iOS®, ANDROID®, WINDOWS®, or other operating systems. In some implementations, the controller 1206 may be implemented as part of the processor 1202.

In some implementations, the NE 1200 may include at least one transceiver 1208. In some other implementations, the NE 1200 may have more than one transceiver 1208. The transceiver 1208 may represent a wireless transceiver. The transceiver 1208 may include one or more receiver chains 1210, one or more transmitter chains 1212, or a combination thereof.

A receiver chain 1210 may be configured to receive signals (e.g., control information, data, packets) over a wireless medium. For example, the receiver chain 1210 may include one or more antennas to receive a signal over the air or wireless medium. The receiver chain 1210 may include at least one amplifier (e.g., a low-noise amplifier (LNA)) configured to amplify the received signal. The receiver chain 1210 may include at least one demodulator configured to demodulate the receive signal and obtain the transmitted data by reversing the modulation technique applied during transmission of the signal. The receiver chain 1210 may include at least one decoder for decoding the demodulated signal to receive the transmitted data.

A transmitter chain 1212 may be configured to generate and transmit signals (e.g., control information, data, packets). The transmitter chain 1212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1212 may also include at least one power amplifier configured to amplify the modulated signal to an appropriate power level suitable for transmission over the wireless medium. The transmitter chain 1212 may also include one or more antennas for transmitting the amplified signal into the air or wireless medium.

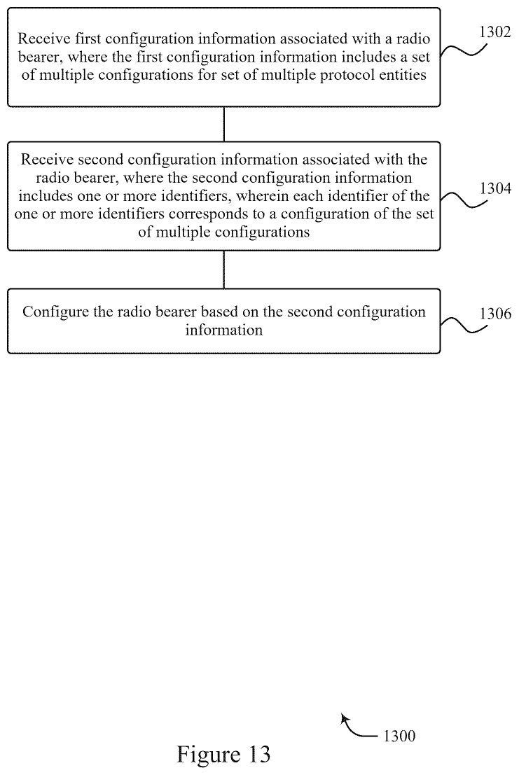

FIG. 13 illustrates a flowchart of a method 1300 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1302, the method may include receiving first configuration information associated with a radio bearer, where the first configuration information includes a set of multiple configurations for a set of multiple protocol entities. The operations of 1302 may be performed in accordance with examples as described herein. In some implementations, aspects of the operations of 1302 may be performed by a UE as described with reference to FIG. 10.

At 1304, the method may include receiving second configuration information associated with the radio bearer, where the second configuration information includes one or more identifiers, where each identifier of the one or more identifiers corresponds to a configuration of the set of multiple configurations. The operations of 1304 may be performed in accordance with examples as described herein. In some implementations, aspects of the operations of 1304 may be performed by a UE as described with reference to FIG. 10.

At 1306, the method may include configuring the radio bearer based on the second configuration information. The operations of 1306 may be performed in accordance with examples as described herein. In some implementations, aspects of the operations of 1306 may be performed a UE as described with reference to FIG. 10.

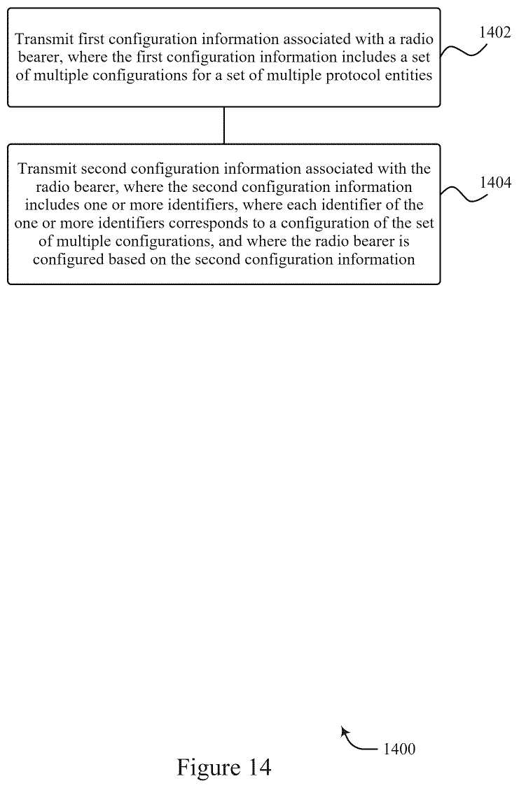

FIG. 14 illustrates a flowchart of a method 1400 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1402, the method may include transmitting first configuration information associated with a radio bearer, where the first configuration information includes a set of multiple configurations for a set of multiple protocol entities. The operations of 1402 may be performed in accordance with examples as described herein. In some implementations, aspects of the operations of 1402 may be performed by an NE as described with reference to FIG. 12.

At 1404, the method may include transmitting second configuration information associated with the radio bearer, where the second configuration information includes one or more identifiers, where each identifier of the one or more identifiers corresponds to a configuration of the set of multiple configurations, and where the radio bearer is configured based on the second configuration information. The operations of 1404 may be performed in accordance with examples as described herein. In some implementations, aspects of the operations of 1404 may be performed by an NE as described with reference to FIG. 12.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
one or more memories; and
one or more processors coupled with the one or more memories and individually or collectively operable to cause the UE to:
receive first configuration information associated with a radio bearer, wherein the first configuration information comprises a plurality of configurations for a plurality of protocol entities;
receive second configuration information associated with the radio bearer, wherein the second configuration information comprises one or more identifiers, wherein each identifier of the one or more identifiers corresponds to a configuration of the plurality of configurations; and
configure the radio bearer based at least in part on the second configuration information.

2. The UE of claim 1, wherein, to configure the radio bearer, the one or more processors are further operable to cause the UE to configure a protocol entity associated with the radio bearer based at least in part on the configuration of the plurality of configurations.

3. The UE of claim 1, wherein the plurality of configurations comprises at least one first configuration and at least one second configuration, wherein a first configuration includes a set of parameters for a protocol entity of the plurality of protocol entities and a second configuration includes a subset of the set of parameters for the protocol entity that differ from the first configuration.

4. The UE of claim 1, wherein, to configure the radio bearer, the one or more processors are further operable to cause the UE to:
deactivate a first configuration of the plurality of configurations and activate a second configuration of the plurality of configurations for the radio bearer based at least in part on a criterion; and
transmit an indication of the activated second configuration.

5. The UE of claim 1, wherein the first configuration information further comprises a plurality of radio bearer configurations, each radio bearer configuration comprising one or more configurations of the plurality of configurations, and the second configuration information comprises an identifier of the one or more identifiers corresponding to a radio bearer configuration of the plurality of radio bearer configurations, and wherein the radio bearer is configured based at least in part on the radio bearer configuration.

6. The UE of claim 1, wherein the first configuration information further comprises a plurality of parameter sets for a functionality associated with the radio bearer, and wherein the radio bearer is configured based at least on part on a parameter set of the plurality of parameter sets.

7. The UE of claim 1, wherein the first configuration information further comprises a plurality of logical channel prioritization (LCP) parameter sets, wherein each LCP parameter set of the plurality of LCP parameter sets corresponds to an identifier of the one or more identifiers, and wherein the one or more processors are further operable to cause the UE to:
receive a signal indicating the identifier of an LCP parameter set; and
apply the LCP parameter set to the radio bearer based at least in part on the signal.

8. The UE of claim 1, wherein the plurality of configurations comprises at least one medium access control (MAC) parameter configuration, and wherein the one or more processors are further operable to cause the UE to receive a message indicating a MAC parameter configuration based at least in part on one or more service requirements.

9. The UE of claim 1, wherein the one or more processors are further operable to cause the UE to transmit assistance information indicating a preferred configuration of the plurality of configurations.

10. The UE of claim 1, wherein each protocol entity of the plurality of protocol entities corresponds to at least one configuration of the plurality of configurations.

11. The UE of claim 1, wherein the plurality of configurations includes at least one of a network equipment (NE)-controlled configuration, a UE-selectable configuration that is indicated to an NE, or a UE-selectable configuration that is not indicated to the NE.

12. A network equipment (NE) for wireless communication, comprising:
one or more memories; and
one or more processors coupled with the one or more memories and individually or collectively operable to cause the NE to:
transmit first configuration information associated with a radio bearer, wherein the first configuration information comprises a plurality of configurations for a plurality of protocol entities; and
transmit second configuration information associated with the radio bearer, wherein the second configuration information comprises one or more identifiers, wherein each identifier of the one or more identifiers corresponds to a configuration of the plurality of configurations, and wherein the radio bearer is configured based at least in part on the second configuration information.

13. The NE of claim 12, wherein the plurality of configurations comprises at least one first configuration and at least one second configuration, and wherein a first configuration includes a set of parameters for a protocol entity of the plurality of protocol entities and a second configuration includes one or more parameters for the protocol entity that differ from the first configuration.

14. The NE of claim 12, wherein the one or more processors are further operable to cause the NE to reconfigure the configuration of the radio bearer based at least in part on one or more quality of service (QoS) parameters associated with a QoS flow that is mapped to the radio bearer.

15. The NE of claim 12, wherein the first configuration information further comprises a plurality of radio bearer configurations, each radio bearer configuration comprises one or more configurations of the plurality of configurations, and the second configuration information comprises an identifier of the one or more identifiers corresponding to a radio bearer configuration of the plurality of radio bearer configuration, and wherein the radio bearer is configured based at least in part on the radio bearer configuration.

16. The NE of claim 12, wherein the first configuration information further comprises a plurality of parameter sets for a functionality associated with the radio bearer, and wherein the radio bearer is configured based at least on part on a parameter set of the plurality of parameter sets.

17. The NE of claim 12, wherein the first configuration information further comprises a plurality of logical channel prioritization (LCP) parameter sets, wherein each LCP parameter set of the plurality of LCP parameter sets corresponds to an identifier of the one or more identifiers, and wherein the one or more processors are further operable to cause the NE to:
transmit a signal indicating the identifier of an LCP parameter set, wherein the LCP parameter set is applied to the radio bearer based at least in part on the signal.

18. The NE of claim 12, wherein the plurality of configurations comprises at least one medium access control (MAC) parameter configuration, wherein the one or more processors are further operable to cause the NE to:
select a MAC parameter configuration based at least in part on one or more service requirements; and
transmit a message indicating the selected MAC parameter configuration.

19. A method performed by a user equipment (UE), the method comprising:
receiving first configuration information associated with a radio bearer, wherein the first configuration information comprises a plurality of configurations for a plurality of protocol entities;
receiving second configuration information associated with the radio bearer, wherein the second configuration information comprises one or more identifiers, wherein each identifier of the one or more identifiers corresponds to a configuration of the plurality of configurations; and
configuring the radio bearer based at least in part on the second configuration information.

20. A method performed by a network equipment (NE), the method comprising:
transmitting first configuration information associated with a radio bearer, wherein the first configuration information comprises a plurality of configurations for a plurality of protocol entities; and
transmitting second configuration information associated with the radio bearer, wherein the second configuration information comprises one or more identifiers, wherein each identifier of the one or more identifiers corresponds to a configuration of the plurality of configurations, and wherein the radio bearer is configured based at least in part on the second configuration information.
